(19) United States
(12) Patent Application Publication
(10) Pub. No.: US 2026/0264824 A1
(43) Pub. Date: Sep. 10, 2026

(54) A MAGNUS ROTOR, ASSOCIATED ASSEMBLIES AND MECHANISMS

(71) Applicant: Anemoi Marine Technologies Limited, London (GB)

(72) Inventors: Luke Neil MCEWEN, Lymington (GB); Joseph Timothy Oliver PLUNKETT, St Albans (GB); David MANSLEY, Bransgore (GB); Duncan STRINGFELLOW, London (GB)

(21) Appl. No.: 19/491,306

(22) PCT Filed: Jun. 6, 2024
(86) PCT No.: PCT/GB2024/051459

§ 371 Date: Dec. 8, 2025

(30) Foreign Application Priority Data
Jun. 8, 2023 (GB) 2308554.1

(51) Int. Cl. B63H 9/02

(52) U.S. Cl. CPC B63H 9/02

(57) ABSTRACT

A Magnus rotor comprising: a rotor rotatable about a rotor axis and having an external surface defining a rotor diameter, the rotor having an internal running surface defining a running surface diameter no greater than 80% of the rotor diameter; a support structure configured to rotatably support the rotor; and, a plurality of wheels, each wheel being rotatably mounted to the support structure so as to rotate about a respective wheel axis extending substantially parallel to the rotor axis and being positioned such that the wheel rolls against the internal running surface as the rotor rotates about the support structure. This disclosure further relates to a wheel assembly, a drive assembly, a biasing assembly and a gimballed wheel mechanism for a Magnus rotor.

### BACKGROUND TO THE INVENTION

Magnus rotors, also known as rotor sails or Flettner rotors, are a type of marine propulsion system that uses rotating cylinders instead of traditional sails or engines to generate forward drive.

The basic principle behind Magnus rotors is the Magnus effect, which describes the force that is generated when a rotating cylinder moves through a fluid. In the case of Magnus rotors, the rotating cylinders (known as a rotor) are placed vertically on the deck of a vessel or ship, that is, with their axis of rotation pointing vertically upwards. An engine or motor is used to rotate the rotors, creating a lift force that pushes the ship forward. This lift force is generated by the difference in air pressure on the front and back of the rotating cylinder, which creates a horizontal force that is perpendicular to the direction of the wind.

One of the primary benefits of Magnus rotors is their potential to reduce fuel consumption and emissions in the shipping industry, translating into significant cost savings for shipping companies and a reduction in greenhouse gas emissions. This is particularly important given the increasing focus on reducing emissions in the shipping industry, which is responsible for a significant percentage of global emissions. The fuel required to propel a ship can be significantly reduced by using one or more Magnus rotors either instead of or in addition to conventional, propeller-driven propulsion.

However, Magnus rotors known in the art have limitations. In particular, Magnus rotors can require high levels of maintenance due to the high level of wear they experience. The bearings supporting the rotor must carry the rotor's static weight, transfer the propulsive force to the ship's structure, absorb vibrations caused by rotor imbalance, and withstand other periodic and/or stresses caused by variable winds or the movement of the ship in high seas, to give a number of examples. In addition, being exposed to the elements in a marine environment leads to additional wear and corrosion, due to salt water and debris making its way into the moving parts of the Magnus rotor. Failure of a Magnus rotor can be highly disruptive, with the ship forced to fall back to its less efficient fuel-burning engines and propellers.

Accordingly, there is a need for more efficient Magnus rotor configurations which can run more reliably and require less maintenance.

### SUMMARY OF THE INVENTION

According to a first aspect there is provided a Magnus rotor comprising: a rotor rotatable about a rotor axis and having an external surface defining a rotor diameter, the rotor having an internal running surface defining running surface diameter no greater than 80% of the rotor diameter; a support structure configured to rotatably support the rotor; and, a plurality of wheels, each wheel being rotatably mounted to the support structure so as to rotate about a respective wheel axis extending substantially parallel to the rotor axis and being positioned such that the wheel rolls against the internal running surface as the rotor rotates about the support structure.

Preferably, the running surface diameter is no greater than 70% of the rotor diameter; more preferably, no greater than 60% of the rotor diameter. A smaller running surface diameter, compared to the rotor diameter results in the plurality of wheels rotating at a lower speed for a given angular velocity of the rotor. This causes a reduction of fatigue, wear, heat and noise.

Preferably, each wheel has an outer surface defining a wheel diameter at least 10% of the rotor diameter. A larger wheel diameter also results in the respective wheel rotating at a lower speed for a given angular velocity of the rotor, thereby allowing for a reduction of fatigue, wear, heat and noise.

Preferably, the plurality of wheels are spaced apart from one another about a pitch circle such that each wheel axis extends through the pitch circle; and, the pitch circle has a pitch diameter no greater than 70% of the rotor diameter; preferably no greater than 50% of the rotor diameter.

The pitch diameter is essentially a representation of the running surface diameter and the wheel diameter when considered in combination. In other words, a smaller running surface diameter and larger wheel diameters both contribute to a smaller pitch diameter for a given rotor (having a consistent rotor diameter). Accordingly, a smaller pitch diameter for a given rotor results in the plurality of wheels rotating at a lower speed for a given angular velocity of the rotor, thereby allowing for a reduction of fatigue, wear, heat and noise.

Preferably, the support structure comprises a hollow tower having a wall with a substantially circular cross-sectional shape; and, at least one of the plurality of wheels lies at least partially within an outer diameter of the tower. Positioning the wheels partially within the tower allows the tower to be wider and provide greater stiffness and strength to the support structure. The wheels may be positioned in a pocket or recess within the tower.

Preferably, one or more of the wheels lying at least partially within the outer diameter of the tower is positioned so that a majority of the or each wheel lies within the outer diameter of the tower. Positioning the wheels so that they are mostly within the tower further increases the possible size of the tower. Preferably at least 60%, at least 70%, or at least 80% of one or more of the wheels lies within the outer diameter of the tower.

Preferably, the rotor further includes a bearing ring having an inner surface or outer surface that is the internal running surface of the rotor; and, a radial flange configured to have an annulus shape with an inner edge that is connected to an outer surface of the bearing ring, and an outer edge which is connected to an inner surface of the rotor. A solid annulus shaped flange may provide greater rigidity and strength than alternatives, such as a network of struts.

Preferably, the radial flange comprises an accessway. This allows personnel and maintenance systems to access the support structure and interior of the rotor above the level of the bearing ring.

Preferably, at least one wheel has an axial height at least 50% of the wheel diameter. This decreases the contact stresses within the wheels as they roll compared to shorter wheels, allowing fewer wheels to be used for a given limiting contact stress.

Preferably, wherein at least one wheel comprises a substantially cylindrical outer surface. This minimises the contact stress compared to a cambered or crowned wheel profile with a point contact, and hence mitigates against wear and hysteresis-related heat generation.

Preferably, at least one wheel comprises a solid tyre; preferably a solid tyre including polyurethane or a completely polyurethane solid tyre. A solid tyre has better wear resistance, higher load capacity, and lower parasitic losses while rolling than a hollow pneumatic tyre, for example.

Preferably, the internal running surface is located in a lower portion of the rotor when the rotor is in use. For example, the internal running surface is located in the bottom 50% of the rotor; optionally in the bottom 30% of the rotor; or even in the bottom 10% of the rotor. This means that the plurality of wheels may be mounted in a correspondingly low position on the support structure. The wheels and associated mechanisms for drive/positioning/suspension of the wheels may be among the heaviest components of the Magnus rotor and, therefore, the cost of the support structure may be substantially reduced by mounting the wheels as close to deck level as possible.

According to a second aspect, there is provided a wheel assembly for a Magnus rotor, the wheel assembly comprising: a support structure; and, a plurality of wheels mounted to the support structure so as to be non-uniformly spaced apart from one another, each wheel rotatable in use to roll against a running surface of a rotor as the rotor rotates.

This wheel assembly allows a given number of wheels to be deployed in the most cost-effective manner by having a higher number of wheels in higher load areas and fewer wheels in lower load areas, avoiding the additional cost of unnecessary wheels in low load areas.

Preferably, each wheel in the plurality of wheels has at least one of:
substantially the same height as each other wheel in the plurality of wheels;
substantially the same diameter as each other wheel in the plurality of wheels;
substantially the same weight as each other wheel in the plurality of wheels; and
substantially the same material composition as each other wheel in the plurality of wheels.

In some examples, a Magnus rotor comprising a wheel assembly according to the second aspect of the invention may additionally include one or more spacer wheels which may be configured to perform a separate function to the plurality of wheels referred to above. For example, one or more spacer wheels may be included simply to provide aesthetic symmetry to the Magnus rotor. Such spacer wheels may be cheaper alternatives to the wheels included in the wheel assembly of the second aspect of the invention. For example, a spacer wheel may be smaller, lighter, made of cheaper materials and/or be configured to carry a significantly lower load than wheels of the wheel assembly. It is to be understood that such spacer wheels would be excluded from any consideration of non-uniform spacing due to the fact that they perform a different function to wheels of the wheel assembly.

Preferably, the wheel assembly has: an aft half oriented in use towards the stern of a ship; and, a forward half oriented in use towards the bow of a ship and comprising a lower number of wheels than the aft half. The purpose of the rotors is to assist ship propulsion, and so the control system is designed to ensure that the thrust loading will be almost entirely concentrated on the aft side of the rotor (the side facing away from the direction of travel of the vessel). Removal of superfluous wheels in the forward half reduces rolling resistance in the wheel assembly.

It will be appreciated that, in some examples, one or two wheels may be positioned such that they cross over from the forward half of the wheel assembly to the aft half. In such examples, the fraction of each wheel lying in each half may be counted depending on the wheel's cross-sectional area. For example, if there are six wheels in total with two wheels in the forward half, three wheels in the rear half and one wheel lying so that 50% of the wheel is positioned in each half, the forward half may be considered as having 2.5 wheels while the aft half may be considered as having 3.5 wheels.

The forward half may have a forward wheel density defined by the number of wheels per support structure in the forward half, the aft half may have an aft wheel density defined by the number of wheels per support structure in the aft half.

Preferably, the forward wheel density is no greater than 75% of the aft wheel density. More preferably, the forward wheel density is no greater than 67% of the aft wheel density.

Preferably, the forward half comprises an accessway positioned between two adjacent wheels. The lower wheel density in the forwards half frees space for equipment and personnel access, cabling, and ducting, compared to a conventional wheel assembly with uniformly spaced wheels.

Preferably, the support structure comprises a plurality of loading arrangements, each configured to, in use, impel a respective wheel towards the running surface; and, at least one loading arrangement impels the corresponding wheel towards the running surface according to a first load characteristic and at least one other loading arrangement impels the corresponding wheel towards the running surface according to a second, different load characteristic. In some examples, the load characteristic refers to the effective stiffness of the loading arrangement. However, in other examples such as those using fluid actuators, the loading arrangement does not have a defined stiffness parameter and the load characteristic refers to the relationship between the loading force and the displacement of the loading arrangement. Using different loading characteristics for different wheels allows resonant modes to be avoided for all thrust directions, as the load may be unevenly distributed between wheels.

Preferably, the first load characteristic results in a lower degree of biasing being applied than the second load characteristic; and, at least one loading arrangement in the aft half is configured to impel the respective wheel according to the first load characteristic and at least one loading arrangement in the forward half is configured to impel the respective wheel according to the second load characteristic. For the forward wheels, being fewer in number and rarely heavily loaded, it may be beneficial to have a higher load characteristic (such as stiffer springs) than the aft wheels.

Preferably, each loading arrangement in the aft half is configured to impel the respective wheel according to the first load characteristic and each loading arrangement in the forward half is configured to impel the respective wheel according to the second load characteristic. Using one set of loading arrangements in the forward half and another set in the aft half accounts for the differing wheel density and loads in the forward and aft halves, without excessively complicating design and maintenance of the wheel assembly.

Preferably, the first and second load characteristics replicate first and second stiffnesses respectively. As previously mentioned, while some components such as springs have an innate stiffness characteristic, other components such as fluid actuators and servos do not. However, the load characteristics of such other components can be controlled so as to replicate the behaviour of a spring. For example, a servo can be controlled to apply a force proportional to the measured extension or displacement of the servo, with the constant of proportionality being equivalent to the stiffness of a spring.

According to a third aspect, there is provided a drive assembly for a Magnus rotor comprising: one or more drive wheel mechanisms, the or each drive wheel mechanism including a drive wheel positionable to, in use, roll against a running surface of a rotor, and a drive mechanism for supplying torque to drive rotation of the drive wheel and, in use, the rotor; and, one or more idler wheel mechanisms, the or each idler wheel mechanism including an idler wheel that is freely rotatable and positionable to, in use, roll against a running surface of a rotor as the rotor rotates, wherein: at least one drive wheel comprises a first tyre having a first tyre composition and at least one idler wheel comprises a second tyre having a second tyre composition different to the first tyre composition; and/or, at least one drive wheel mechanism further includes a biasing mechanism configured to, in use, bias the corresponding drive wheel towards the running surface, the biasing mechanism configured to increase the degree of bias applied as the torque supplied by the drive mechanism increases.

In some examples, the one or more drive wheels and the one or more idler wheels may be positionable, in use, to roll against the same running surface of a rotor. In other examples, the one or more drive wheels may be positionable, in use, to roll against a first running surface of a rotor while the one or more idler wheels may be positionable, in use, to roll against a second running surface of the rotor, different to the first running surface.

Preferably, the first tyre is a pneumatic tire.

Preferably, the first tyre composition is formed from a material that is or includes a rubber material.

Preferably, the second tyre is solid tire.

Preferably, the second tyre composition is formed from a material that is or includes a polyurethane material and/or a metal material.

Preferably, the polyurethane material has a Shore hardness of 70 A or harder.

Preferably, the metal material has a Brinell hardness of 100 HB or harder.

Preferably, the drive assembly further includes a support structure upon which the one or more drive wheel mechanisms and the one or more idler wheel mechanisms are mounted, wherein at least one biasing mechanism comprises a swing mount pivotably connecting the corresponding drive wheel to the support structure, and the said biasing mechanism is configured to bias the swing mount to pivot relative to the support structure such that the drive wheel is urged towards the running surface. This ensures that a contact force is maintained between the drive wheel and running surface sufficient to prevent slipping, without causing excess wear on the wheel or running surface as the torque supplied by the drive mechanism increases.

According to a fourth aspect, there is provided a biasing assembly for a wheel of a Magnus rotor, the biasing assembly comprising: a first coupling connectable to a support structure for mounting one or more wheels relative to a vessel; a second coupling connectable to a wheel rotatable about a wheel axis, whereby in use the wheel rolls against a running surface of a rotor as the rotor rotates about a rotor axis; and a biasing member interconnecting the first and second couplings and configured to urge the wheel axis, in use, towards the running surface with a displacement dependent degree of force, wherein the biasing member urges the wheel towards the running surface according to a first force characteristic while the wheel axis lies in a first displacement region and urges the wheel towards the running surface according to a second, different force characteristic while the wheel axis lies in a second displacement region.

Preferably, in use the first displacement region lies closer to the running surface, in a neutral position, than the second displacement region. The running surface may be considered in a neutral position when no external loading is applied to it. In some examples, the running surface may be an inwardly facing surface, in which case the first displacement region would lie further from the rotor axis than the second displacement region. In other examples, the running surface may be an outwardly facing surface, in which case the first displacement region would lie closer to the rotor axis than the second displacement region.

Preferably, the first force characteristic results in a lower degree of biasing being applied than as a result of the second force characteristic.

Preferably, the first displacement region transitions to the second displacement region at a predetermined transition point. The biasing assembly may be configured in use such that with zero external load applied, the wheel axis is positioned at the transition point.

Preferably, the biasing member comprises a first biasing element defining the first force characteristic and a second biasing element defining the second force characteristic.

Preferably, the first biasing element is or includes a spring, a pneumatic actuator and/or a hydraulic actuator. The spring may be a coil spring or a leaf spring, for example.

Preferably, the first biasing element is or includes a pneumatic or a hydraulic actuator having a pressure reservoir.

Preferably, the second biasing element is or includes a resilient block, preferably formed from or including an elastomeric material.

Preferably, the second force characteristic is selected to in use prevent resonant oscillation of the rotor in a desired operating speed range.

According to a fifth aspect, there is provided a wheel assembly for a Magnus rotor, the wheel assembly comprising: a support structure defining a pitch circle; at least one wheel mounted to the support structure and rotatable about a wheel axis to, in use, roll against a running surface of a rotor as the rotor rotates; and at least one biasing assembly according to any example of the fourth aspect, wherein the or each first coupling is connected to the support structure and the or each second coupling is connected to a respective wheel.

The at least one wheel may be a plurality of wheels and the at least one biasing assembly may be a respective plurality of biasing assemblies. The second force characteristic of each biasing assembly may replicate a stiffness and the second force characteristics of the plurality of biasing assemblies may replicate a stiffness effective on the rotor in use that is greater than a desired moving mass of the rotor multiplied by the square of a desired maximum operating angular velocity of the rotor.

Preferably, the stiffness effective on the rotor in use is between 1.5 times and 10 times the effective moving mass of the rotor multiplied by the square of the maximum operating angular velocity of the rotor. More preferably, the stiffness effective on the rotor in use is between 2 times and 5 times the effective moving mass of the rotor multiplied by the square of the maximum operating angular velocity of the rotor.

According to a sixth aspect, there is provided a gimballed wheel mechanism for a Magnus rotor, the gimballed wheel mechanism comprising: a wheel rotatable about a wheel axis to, in use, roll against a running surface of a rotor as the rotor rotates about a rotor axis; a mounting assembly rotatably supporting the wheel, in use relative to a support structure, and including a gimballing support configured to allow pivoting of the wheel axis about a gimballing axis which extends substantially perpendicularly to the wheel axis, wherein, in use, the wheel axis and the rotor axis extend along a common radial plane and the gimballing support is configured such that the gimballing axis additionally extends perpendicularly to the radial plane.

Preferably, an external surface of the wheel is substantially cylindrical so that, in use, a line or area of contact is established between the wheel and the running surface with a length substantially equivalent to a height of the wheel, and a centre of the line or area of contact represents a centre of effort between the wheel and the running surface.

Preferably, the height of the wheel is equal to or greater than 50% of a diameter of the wheel.

The gimballing axis may extend closer to the line or area of contact than to the wheel axis; preferably, the gimballing axis extends through the line or area of contact; more preferably, the gimballing axis extends through the centre of effort. It will be appreciated that the gimballing axis may pass approximately through the centre of effort in the sense that the gimballing axis passes sufficiently close to the centre of effort that the disparity is negligible for the functionality of the gimballed wheel mechanism.

Preferably, the gimballing support defines first and second pivot points whereby the gimballing support provides a gimballing support force acting along a gimballing support axis extending through the first and second pivot points; and, the pivot points are arranged relative to one another such that the gimballing support axis is coincident with the centre of effort. The gimballing support axis may coincide directly with the centre of effort, or coincide substantially in the sense that the gimballing support axis passes close to the centre of effort.

Preferably, the gimballed wheel mechanism further includes a biasing support configured to resist pivoting of the wheel axis about the gimballing axis. This advantageously prevents unwanted rotation of the wheel about the gimballing axis under its own weight.

Preferably, the biasing support provides a biasing support force acting along a biasing support axis that opposes a rotational force acting about the centre of effort of the gimballed wheel mechanism, the rotational force arising from the weight of the gimballed wheel mechanism.

Optionally, the gimballing axis extends closer to the centre of gravity of the gimbaled wheel mechanism than to a curved external surface of the wheel. More preferably, the gimbaling axis extends substantially through the centre of gravity of the gimballed wheel mechanism. The gimballing axis may extend directly through the centre of gravity, or approximately through in the sense that the gimballing axis passes close to the centre of gravity.

According to a seventh aspect, there is provided a Magnus rotor according to any example of the first aspect, wherein the plurality of wheels define one or more of:
a wheel assembly according to any example of the second aspect;
a drive assembly according to any example of the third aspect; and
a wheel assembly according to any example of the fifth aspect.

At least one wheel may form a part of a gimballed wheel mechanism according to any example of the sixth aspect.

The features and advantages of the first to sixth aspects of the disclosure and its embodiments apply mutatis mutandis to the seventh aspect of the disclosure and its examples.

According to an eighth aspect, there is provided a Magnus rotor comprising:
a rotor rotatable about a rotor axis and having an internal running surface;
a support structure configured to rotatably support the rotor; and,
a plurality of wheels, each wheel being rotatably mounted to the support structure so as to rotate about a respective wheel axis extending substantially parallel to the rotor axis and being positioned such that the wheel rolls against the internal running surface as the rotor rotates about the support structure,
the plurality of wheels defining one or more of:
a wheel assembly according to any example of the second aspect;
a drive assembly according to any example of the third aspect; and
a wheel assembly according to any example of the fifth aspect.

At least one wheel may form a part of a gimballed wheel mechanism according to any example of the sixth aspect.

The features and advantages of the second to sixth aspects of the disclosure and its embodiments apply mutatis mutandis to the eighth aspect of the disclosure and its examples.

Although the examples have been thus far referred to a Magnus rotor in relation their applications for ship propulsion, it will be understood that they may also be suitable for other kinds of vessels or vehicles, such as aircraft and land vehicles.

### BRIEF DESCRIPTION OF THE DRAWINGS

FIGS. 1(a) and 1(b) show simplified views of an exemplary Magnus rotor, with FIG. 1(a) being a cross-sectional view through a plane aligned with the rotor's axis of rotation, while FIG. 1(b) is a cross-sectional view through plane A-A of FIG. 1(a).

FIG. 2 shows an exemplary wheel for use in a wheel assembly of a Magnus rotor.

FIGS. 3(a) and 3(b) respectively show simplified cross-sectional views of exemplary first and second wheel assemblies for Magnus rotors with non-uniform wheel spacing through a plane extending perpendicularly to the rotor's axis of rotation.

FIG. 4 schematically illustrates an example of a drive assembly for a Magnus rotor through a plane extending perpendicularly to the rotor's axis of rotation.

FIGS. 5(a) and 5(b) show an exemplary drive wheel mechanism for use in a drive assembly for a Magnus rotor, with FIG. 5(a) showing a cross-sectional view through a plane aligned with the rotor's axis of rotation, and FIG. 5(b) being a further cross-sectional view through plane B-B of FIG. 5(a).

FIGS. 6(a) and 6(b) show simplified views of a Magnus rotor including a plurality of first biasing assemblies, with FIG. 6(a) being a cross-sectional view through a plane aligned with the rotor's axis of rotation, while FIG. 6(b) shows an enlarged view of one of the first biasing assemblies of FIG. 6(a).

FIG. 7 shows a graph of force F against linear displacement x of a biasing member forming a part of the first biasing assemblies shown in FIGS. 6(a) and 6(b).

FIG. 8 shows an example of a second biasing assembly.

FIGS. 9(a) and 9(b) show a simplified view of the Magnus rotor of FIGS. 1(a) and 1(b) when deflecting under load, with FIG. 9(a) being a cross-sectional view through a plane aligned with the rotor's axis of rotation, while FIG. 9(b) shows an enlarged view of a wheel and a portion of the rotor of FIG. 9(a) and an associated running surface.

FIG. 10 shows a first exemplary gimballed wheel mechanism for a Magnus rotor, wherein the gimballing axis is aligned with the wheel's centre of gravity.

FIG. 11 shows a second exemplary gimballed wheel mechanism for a Magnus rotor, wherein the gimballing axis is aligned with the wheel's centre of effort.

### DETAILED DESCRIPTION

### Magnus Rotor

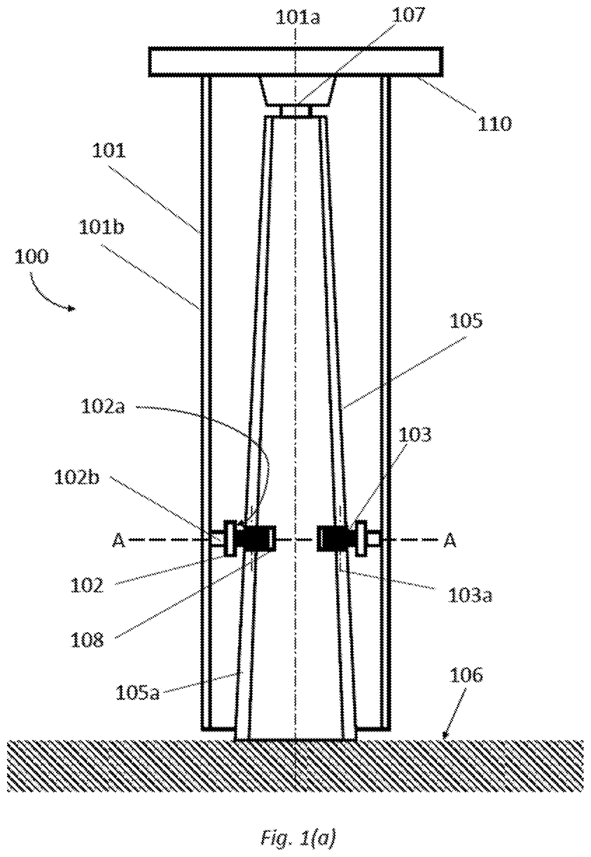

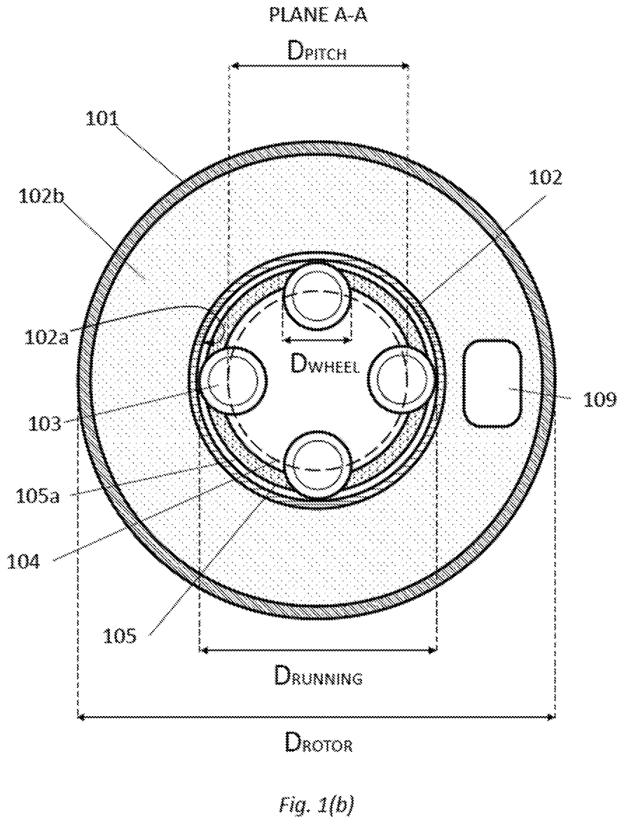

Referring to FIGS. 1(a) and 1(b), an exemplary Magnus rotor 100 consists of a rotor 101 which is rotatable about a rotor axis 101a, i.e. the rotor's axis of rotation. The rotor 101 is substantially cylindrical, with an outer wall 101b extending vertically and parallel to the rotor axis and a top disc 110 extending radially from the rotor axis 101a. The rotor 101 is supported by a support structure in the form of a carrier 105 which, in use, extends from the deck 106 of a vessel, such as a ship. A drive torque can be applied to the rotor 101 to cause it to rotate around the carrier 105, i.e. the support structure.

The rotor 101 comprises a bearing ring 102 connected to the outer wall 101b of the rotor 101 by means of a radial flange 102b. The bearing ring 102 is positioned radially inwards from the outer wall 101b of the rotor 101 towards the carrier 105. In the embodiment shown, the bearing ring 102 is annular with a rectangular cross-section. The bearing ring may, however, have different shapes in other embodiments, such as an I-shaped or hollow cross-sectional shape. The radial flange 102b joins the radially outermost edge of the bearing ring 102 to the rotor 101 such that the bearing ring 102 rotates with the rotor 101. The radial flange 102b is a continuous annulus, like the bearing ring 102. This means that the radial flange 102b connects to the bearing ring 102 and rotor 101 along its whole circumference.

The bearing ring 102, radial flange 102b, and rotor 101 may joined together by welding, or other fastening means. In some examples, the radial flange and bearing ring 102 may be formed as a single component, e.g. a flange with a “T”-shaped cross-section wherein the top edge of the “T” forms an inner surface of the bearing ring, and the bottom edge of the “T” is joined to the rotor. In further examples, the bearing ring and radial flange may be formed integrally with the rotor.

In the embodiment shown, the aforementioned inner surface of the bearing ring 102 defines an internal running surface 102a. The bearing ring 102 makes contact along its running surface 102a with a plurality of wheels 103. The wheels 103 are rotatably mounted to the carrier 105, that is, supported by the carrier 105 such that they rotate about their respective wheel axes 103a. The wheel axes 103a are arranged parallel to the rotor axis 101a, so as to minimise wear between the bearing ring 102 and the wheels 103. The wheels 103 are positioned such that each wheel 103 rolls against the running surface 102a of the bearing ring 102 as the bearing ring 102 rotates. The wheels 103 are covered by the rotor 101, and more particularly by the outer wall 101b of the rotor 101, thus providing protection from weather and salt-water corrosion.

In this example, the internal running surface 102a is located in a lower portion of the rotor 101. That is to say, the internal running surface 102a is located in the bottom 50% of the rotor 101. The plurality of wheels 103 are therefore mounted in a correspondingly low position on the carrier 105. The wheels 103 and associated mechanisms for drive/positioning/suspension of the wheels (not shown) may be among the heaviest components of the Magnus rotor and, therefore, the cost of the support structure may be substantially reduced by mounting the wheels 103 close to the deck 106. In other examples, the internal running surface may be located lower, such as in the bottom 30% of the rotor; or even in the bottom 10% of the rotor.

In the embodiment shown, the running surface diameter D_{RUNNING} defined by the running surface of the bearing ring 102 is no greater than 80% of the outer diameter of the outer wall 101b of the rotor 101 (i.e. no greater than 80% of the notional rotor diameter D_{ROTOR}). Also, each wheel 103 has a wheel diameter D_{WHEEL}, which may or may not be defined by an outer surface or tyre surface of the wheel, that is at least 10% of the rotor diameter D_{ROTOR}. A smaller running surface diameter D_{RUNNING} and/or a larger wheel diameter D_{WHEEL} results in the wheels 103 spinning more slowly for a given angular velocity, i.e. rate of rotation, of the rotor 101. This results in less fatigue, wear, heat and noise. In other embodiments, the running surface diameter may be no greater than 70% or even 60% of the rotor diameter, further reducing wear.

In alternative embodiments, an outer surface of a bearing ring may define a internal running surface of a rotor. In such embodiments, the plurality of wheels would be arranged with each wheel positioned between the bearing ring and the rotor, either above or below a radial flange connecting the bearing ring to the rotor.

It is to be understood that the notional rotor diameter D_{ROTOR} is defined as the outer, i.e. exterior, diameter of the outer wall 101b of the rotor 101, excluding the top disc 110. In the embodiment shown, the exterior diameter of the outer wall 101b of the rotor 101 is substantially consistent along the height of the rotor. However, in other examples (not shown), the exterior diameter of the outer wall of the rotor may vary along the height of the rotor. In such examples, the rotor diameter may be considered as the mean average exterior diameter of the outer wall of the rotor, excluding the top disc.

In some examples, the rotor diameter is between 3 and 6 meters.

The plurality of wheels 103 are spaced around a pitch circle 104, indicated by a dashed line in FIG. 1(b). The pitch circle 104 is centred on the rotor axis 101a, with a diameter defined by the location of the plurality of wheel axes 103a. That is, each wheel axis 103a is arranged to extend through the pitch circle 104. By spacing the wheels 103 circumferentially around a pitch circle, multiple points of contact can be established with the bearing ring 102 around its circumference, i.e. around its inner running surface 102a. This allows lateral forces to be transferred between the rotor 101 and carrier 105 in multiple directions perpendicular to the rotor axis 101a.

For a given diameter D_{ROTOR} of rotor 101, the diameter of the pitch circle 104 decreases as the diameter D_{WHEEL} of each wheel 103 increases, or as the running surface diameter D_{RUNNING} defined by the running surface 102a of the bearing ring 102 decreases. It follows that a smaller pitch circle 104 diameter D_{PITCH} corresponds to less wear and noise. Accordingly, in some embodiments the pitch circle 104 has a pitch diameter D_{PITCH} no greater than 70%, 60% or even 50% of the diameter D_{ROTOR} of the rotor 101.

In the embodiment shown, the carrier 105 comprises a hollow tower 105a having a wall with a substantially circular cross-sectional shape. For example, the tower 105a may be conical as shown, or cylindrical, or ogive, or comprise a combination of cylindrical sections and conical sections. A cross-sectional shape defining a regular shape with five or more sides (e.g., a pentagon, a hexagon, a heptagon, etc.) will be understood as substantially circular in this context.

Additionally, in the embodiment shown, each of the plurality of wheels 103 lies at least partially within the tower 105a. That is, viewed from above (i.e. as shown in FIG. 1(b)), the outline of each wheel 103 overlaps with the outline of the tower 105a. This allows the tower 105a to be wider and, thereby provide greater stiffness and strength to the carrier 105 and plurality of wheels 103, for an arrangement of wheels 103 on a given pitch diameter D_{PITCH}. In some other examples (not shown), the wheels may be positioned such that their wheel axes lie on the outer circumference of the tower (or, where the tower has a polygonal cross-section rather than circular, the circumference defined by the corners of the polygon). In other words, in such other examples, the pitch circle is coincident with the outer circumference of the tower. In still further other examples, one or more wheels are positioned such that the majority of each wheel lies within the tower. In other words, the pitch circle has a smaller diameter than the tower and carrier. This further increases the diameter of the tower relative to a given pitch diameter, and thus further reduces bending stresses due loads exerted on the rotor 101. In some examples, 60%, 70% or even 80% of the cross-section of each wheel lies within the outer circumference of the tower.

It will be appreciated that the outer circumference of the tower 105a may vary with height, for example if it has a conical shape as is the case in the embodiment shown. Accordingly, when considering the position of the wheels 103 relative to the tower 105a, the outer circumference is to be considered at a plane A-A as shown in FIG. 1(a), that is, a plane level with the middle of the wheels 103.

In known Magnus rotors, an accessway may be provided within the carrier to allow maintenance personnel to pass through, for example. In the embodiment shown, provision of a suitably sized accessway allowing passage through the carrier may be challenging due to the bearing ring 102 restricting the space available for the carrier 105 while large diameter wheels 103 and associated machinery and support structures restrict space within the carrier 105. This could complicate maintenance of the Magnus rotor 100. For this reason, the radial flange 102b in the embodiment shown comprises an accessway 109 in the form of an access hatch which is simply an opening extending through the radial flange 102b.

Providing the accessway 109 through the radial flange 102b allows the diameter of the running surface 102b to be made smaller, i.e. the running surface diameter D_{RUNNING} of the running surface 102a to be smaller, and/or the wheel diameters to be made larger, because the requirement for an accessway within the carrier 105 can be removed.

In other examples, the accessway may include a door, flap or other movable closure which can be used to seal the accessway when not in use, preventing air currents from circulating through the accessway. The accessway 109 shown is large enough for maintenance personnel to pass through, allowing them to enter the interior space between the rotor 101 and carrier 105. In other examples, however, the accessway is smaller, and sized to allow access only for tools and monitoring equipment such as cameras because although a larger accessway 109 facilitates access, it may potentially lead to increased structural stresses in the radial flange 102b.

In the example embodiment shown, the carrier 105, and more particularly the tower 105a thereof, contains a respective housing 108 which surrounds the portion of each wheel within the tower 105a, providing additional protection for each wheel 103. (Any effect that the housings have on the shape of the tower 105a is not to be taken into account when considering the outer circumference of the tower 105a.)

In the example shown in FIG. 1(a), an upper bearing assembly 107 is provided. Accordingly, the plurality of wheels 103, bearing ring 102 and radial flange 102b may be considered together as forming a lower bearing assembly. In this example, the upper bearing assembly 107 is located at the top of the carrier 105 and is configured to support axial loads from the rotor 101 (principally the weight of the rotor 101 itself), meaning that the bearing ring 102 and wheels 103, i.e. the lower bearing assembly, principally transfer lateral loads from the rotor 101. In some examples, the drive torque is provided, i.e. applied, to the rotor through the upper bearing assembly, for example by means of a driveshaft aligned with the rotor axis and extending up through the carrier to connect to the rotor. In alternate examples, the drive torque is provided through one or more of the plurality of wheels 103, as will be discussed in further detail below.

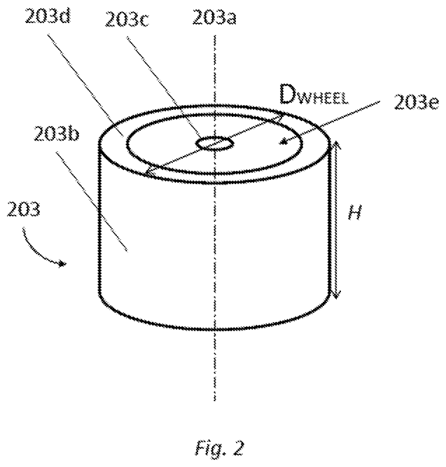

Referring now to FIG. 2, a wheel 203 for use in any previously described example or embodiment, including the embodiment shown, is configured to rotate around a wheel axis 203a. The wheel has a wheel diameter D_{WHEEL} and an axial height H (as measured along the direction of the wheel axis 203a). The axial height H is at least 50% of the wheel diameter D_{WHEEL}. That is, the wheel 203 is tall compared to its diameter. This decreases the contact stresses, allowing fewer wheels to be used for a given limiting contact stress, e.g. compared to shorter, flatter wheels known in the art.

The outer surface 203b of the wheel 203 is configured to make rolling contact with the bearing ring 102, specifically the running surface 102a, without sliding or causing significant friction. To maximise contact area while minimising wear, the shape of the outer surface 203b may be made to match with the shape of the running surface 102a of the bearing ring 102. In the example shown, the wheel 203 has a substantially cylindrical outer surface 203b, configured to roll against a substantially flat running surface 102a of a bearing ring 102. Such a wheel shape for a flat running surface 102a minimises contact stresses compared to a cambered or crowned wheel profile, and hence mitigates against wear and hysteresis-related heat generation.

Additionally, the wheel 203 shown comprises a tyre 203d attached to the rim of a wheel hub 203e. The wheel hub 203e comprises a bore 203c configured to receive an axle about which the wheel 203 rotates. In the example shown, the tyre 203d is formed of polyurethane or from a material including polyurethane. In other examples, the tyre may be formed of or from a material including steel. Polyurethane tyres offer lower rolling resistance compared to other kinds of tyres, such as rubber tyres. Preferably the tyre 203d is made as stiffly as possible, to reduce rolling resistance and heating due to hysteresis in the tyre 203d. One way to achieve this is to use a solid tyre, and more particularly a solid polyurethane tyres, as opposed to e.g. inflatable, pneumatic or hollow tires. The stiffness of the tyre 203d can be further increased by making the tyre 203d as hard and as thin as possible for a given material, increasing the wear-resistance, load capacity, and reducing parasitic losses. The thermal stresses on the tyre 203d may be further reduced by using a wheel hub 203e comprising a material with high thermal conductivity, such as aluminium. This allows heat from rolling resistance to be quickly transferred out of the tyre 203d, increasing the lifetime of the tyre 203d.

### Wheel Assembly

The wind and inertial loading applied to the rotor of a Magnus rotor are not equally distributed around the circumference of the rotor. The purpose of the rotor is to assist ship or other vessel propulsion, and so an associated control system is usually designed to ensure that the thrust loading will be almost entirely concentrated on the aft side of the rotor (that is, the side facing away from the direction of travel of the vessel) other than occasionally due to transient changes in wind direction. The inertial loads will be concentrated on the sides of the rotor perpendicular to the direction of travel, as rolling accelerations onboard a ship or other, e.g. seaborne, vessel are generally much higher than pitching accelerations. Therefore, when wheels 103; 203 are distributed evenly around a pitch circle 104 (as shown in FIG. 1(b), for example), the forward-most wheels would be the least loaded on average, seeing little thrust and low inertial forces.

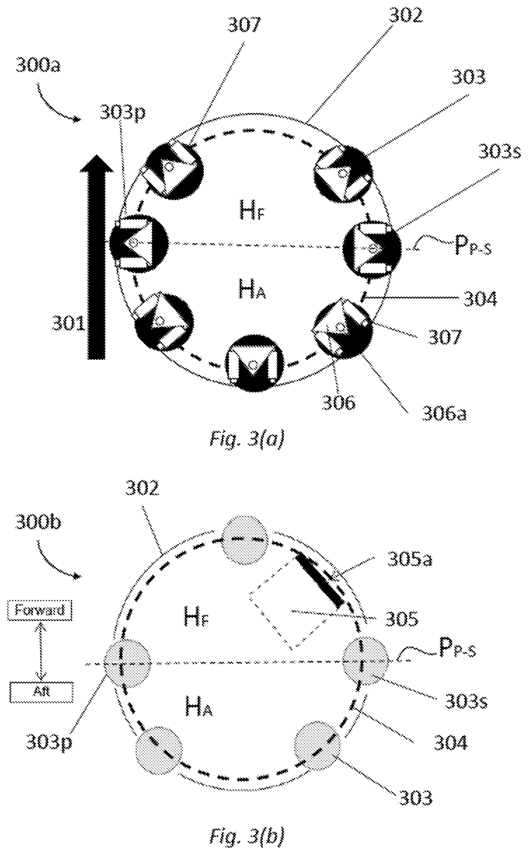

FIG. 3(a) shows an alternative, more efficient, first wheel assembly 300a for a Magnus rotor. The first wheel assembly 300a comprises a plurality of wheels 303 mounted to a support structure 302, which may or may not be, or include, a carrier 105 such as is shown in the exemplary Magnus rotor 100 of FIGS. 1(a) and 1(b).

The wheels 303 are each rotatable such that in use, they roll against a running surface of a rotor (not shown in FIG. 3(a)). Additionally the wheels 303 have substantially the same height H (i.e. as defined in relation to the wheel 203 shown in FIG. 2) as one another, as well as being substantially the same weight as one another, and having substantially the same material composition as one another, although this need not necessarily be the case in other embodiments of the invention.

The fore, aft, port and starboard sides of the rotor are defined in relation to the direction of travel 301, indicated by the arrow. That is, it is assumed that a ship's direction of travel is effectively aligned with the bow of the ship (or other vessel). The support structure 302 and, in this example, the wheel axes define a pitch circle 304, as previously described in relation to FIG. 1(b). However, rather than being evenly distributed circumferentially around the pitch circle 304, the wheels 303 are non-uniformly spaced apart from one another around the pitch circle 304. More particularly, the wheels 303 are spaced more closely together at the areas of higher loading, i.e. at the aft, and port and starboard, sides of the rotor, and spaced further apart at the forwards side of the rotor. In the example shown in FIG. 3(a), this results in the effective removal of a front-most wheel 303. This frees space for equipment and personnel access, cabling, and ducting within the support structure 302. In addition, the superfluous costs incurred by the inclusion of a forward-facing wheel are removed (including the cost of the equipment, installation, maintenance, and weight of the wheel and its supporting equipment). Rolling resistance is also reduced because of the removal of a superfluous wheel, without a significant increase of contact stress on the remaining wheels 303 (since the effectively removed wheel was not carrying significant loads).

In other examples (not shown), the wheels may be a variety of sizes and the wheel axes may therefore not lie on a pitch circle. In such examples, the spacing of the wheels may instead be based on the spacing around the running surface of adjacent points of contact between the wheels and the running surface.

Returning to the wheel assembly 300a shown, it can be divided into a forward half H_{F} and an aft half H_{S} along a port-starboard midplane P_{P-S} of an associated rotor. A wheel density can then be defined, in relation to each of the forwards and aft halves H_{F}, H_{A} of the wheel assembly 300a, as the number of complete wheels 303 per support structure 302 in each half H_{F}, H_{A}. Accordingly, it follows in the first embodiment wheel assembly 300a, That the front wheel density is 3, as there are two wheels 303 fully located in the forwards half H_{F} and the port-most wheel 303p and starboard-most wheel 303s each count as half a wheel because they are each bisected by the port-starboard midplane P_{P-S}, i.e. each is halfway into the forwards half H_{F}. Similarly, the aft wheel density is 4, since there are three complete wheels 303 and two half-wheels 303p, 303s in the aft half H_{A}. The forwards wheel density is therefore 75% of the aft wheel density.

In addition to the foregoing, in the first embodiment wheel assembly 300a, each wheel 303 is mounted to the wall of the support structure 302 by means of a mounting bracket 306 and a loading arrangement 307. Each wheel 303 is connected to the mounting bracket 306 via an axle 306a about which the wheel 303 can rotate. The mounting bracket 306 is, in turn, connected to the support structure 302 via the loading arrangement 307. The loading arrangement 307 impels the wheel 303 radially outwards, i.e. towards a running surface against which the wheel 303 is, in use, configured to roll along. That is, each loading arrangement 307 provides a force in the radially outwards direction to the corresponding wheel 303, i.e. each loading arrangement 307 may be considered, in use, to bias the corresponding wheel 303 towards the running surface. This ensures that, in use, a desirable degree of contact force is maintained between each wheel 303 and the running surface, as well as providing a restoring force for returning a given wheel 303 into contact with the running surface if it is displaced by, e.g. a bump on the running surface.

The force applied by the loading arrangement 307 to the wheel 303 may take the form of a load characteristic. In the embodiment shown, the loading arrangement 307 comprises a pair of springs (although fewer than or more than two springs may be utilised), which are configured to exert a tension force that pulls the corresponding wheel 303 towards the running surface. The load characteristic of such a loading arrangement 307 is the effective stiffness of the pair of springs. In another example (not shown), the loading arrangement 307 may instead comprise an active actuator such as a computer-controlled piston. The loading characteristic of such a loading arrangement is the force applied by the actuator, e.g. piston, to the wheel, which may be configured as a function of the radial displacement of the wheel from the running surface.

To achieve a required minimum total effective stiffness, e.g. so as to avoid resonant modes in a rotor of a Magnus rotor under all thrust directions, it can be advantageous for the load characteristic of the unevenly distributed wheels 303 in a first wheel assembly type, as described hereinabove, to be different at given wheel locations. For example, where each loading arrangement 307 comprises at two springs, as shown, the loading arrangement 307 of each wheel 303 in the forward half H_{F}, being fewer in number and rarely heavily loaded, may have stiffer springs than the loading arrangement 307 for each wheel 303 in the aft half H_{A}. That is, the load characteristic (the stiffness) of each loading arrangement 307 for the wheels 303 in the forward half H_{F} is higher than the load characteristic for the wheels 303 in the aft half H_{A}. Accordingly, preferably each loading arrangement for wheels 303 in the forwards half H_{F} has a first effective stiffness, and each loading arrangement for wheels 303 in the aft half H_{A} has a second effective stiffness, and more preferably the first stiffness is greater than the second stiffness, although this need not necessarily be the case.

FIG. 3(b) shows a second exemplary wheel assembly 300b which is similar to the first wheel assembly 300a with like features sharing the same reference numerals Accordingly, in the second wheel assembly 300b, the wheels 303 are similarly spaced non-uniformly about a pitch circle 304 defined by a support structure 302, but similar mounting brackets and loading arrangements have been omitted from FIG. 3(b) for the purposes of clarity.

Additionally, as in the first wheel assembly 300a, the wheels 303 of the second wheel assembly 300a have substantially the same height H (i.e. as defined in relation to the wheel 203 shown in FIG. 2) as one another, as well as being substantially the same weight as one another, and having substantially the same material composition as one another, although this need not necessarily be the case in other embodiments of the invention.

While the wheels 303 in the second wheel assembly 300b are arranged non-uniformly about the pitch circle 304, they are instead arranged in such a way that there is only a single wheel 303 fully located in the forwards half H_{F} and only two wheels 303 fully located in the aft half H_{F}. Defining the wheel densities as previously described, the second wheel assembly 300b has a forwards wheel density of 2 and an aft wheel density of 3. The forwards wheel density is therefore about 67% of the aft wheel density. In other examples (not shown), the ratio between the forward wheel density and aft wheel density may be even lower. In the second wheel assembly 300b shown, the thrust loading is generally transferred through the two aft-most wheels 303, the main inertial loads due to rolling are transferred through the port- and starboard-most wheels 303p, 303s, meaning that the single forwards-most wheel 303 is only primarily needs to transfer low inertial loads due to pitching.

The lack of wheels 303 in the forwards half H_{F} of the support structure 302 of the second wheel assembly 300b provides the opportunity to simplify the access design of the structure's interior. An accessway 305 can be positioned in the large circumferential gap between the single wheel 303 in the forwards half H_{F} and an adjacent wheel 303p or 303s on either the port or starboard side. As previously described, an accessway 305 may be large enough for personnel to pass through fully, on only large enough to serve as a conduit for cabling, fluid pipes, or simply as a hole through which to insert monitoring devices such as cameras.

In the second wheel assembly 300b embodiment shown, the wide spacing of the wheels 303 in the forwards half H_{F} of the support structure 302 allows the accessway 305 to be large enough to optionally include a ladder 305a, thus enabling personnel to pass through the support structure 302 more easily.

The first and second wheel assemblies 300a, 300b described hereinabove may be used in conjunction with any previously described Magnus rotor example or embodiment. That is, as mentioned, the support structure 302 in each of FIG. 3(a) or FIG. 3(b) may be, or form a part of, the carrier 105 of the exemplary Magnus rotor 100 of FIGS. 1(a) and 1(b), and the wheels 303 may be arranged to roll against the running surface 102a of a bearing ring 102 of such a Magnus rotor 100, as previously described. It will also be understood that either of the first or second wheel assembly 300a, 300b may also be used in conjunction with other Magnus rotor designs. For example, one or other of the first and second wheel assemblies 300(a), 300(b) may be configured such that the wheels 303 run directly against the wall of a rotor, rather than against a bearing ring or other running surface having a reduced diameter compared to the rotor diameter.

### Drive Assembly

As previously mentioned, in some examples one or more wheels may be used not only to transfer loads between a rotor and a support structure such as a carrier, but also to drive the rotation of the rotor. Driving the rotation of the rotor via one or more wheels, e.g. via a lower drive assembly, offers several advantages over driving the rotor through an upper bearing assembly. Firstly, the weight in the resulting Magnus rotor is distributed lower down due to the heavy drive assembly being situated lower, with less weight otherwise aloft in the upper bearing assembly of, e.g. a carrier or tower. Such distribution of weight lower down provides a virtuous circle with regards to overall Magnus rotor weight; the less weight aloft, the lower the bending stresses at the bottom of the tower (due to inertial forces), and so the less steel required in the tower, i.e. support structure, and so on. Secondly, equipment access is simplified. The drive assembly of the rotor is an area likely requiring much maintenance (and possible component replacements) throughout the operating life of the rotor. It is therefore clearly advantageous to have the drive system placed lower down the rotor, where components are more easily accessible. Additionally, gearing requirements are reduced. Low-cost AC induction motors operating from typical ship electrical power at 60 Hz frequency AC have an efficient top speed of around 1200 rpm, whereas a 5 m diameter rotor needs to turn at a maximum speed of around 200 rpm, requiring a reduction in speed of around 6 times. Although this can be achieved by driving the rotor through a shaft in the upper bearing assembly using a gearbox, belt drive or chain drive, this undesirably causes power losses and generates heat. If instead one or more wheels in a wheel assembly is driven, to thus create a drive assembly, the ratio of the rotor running surface to wheel diameter can be arranged to around 6, and the need for gearing is thus removed. Finally, using a plurality of wheels in a drive assembly as driving wheels allows for distributed power transmission, alternate running modes, and additional redundancy.

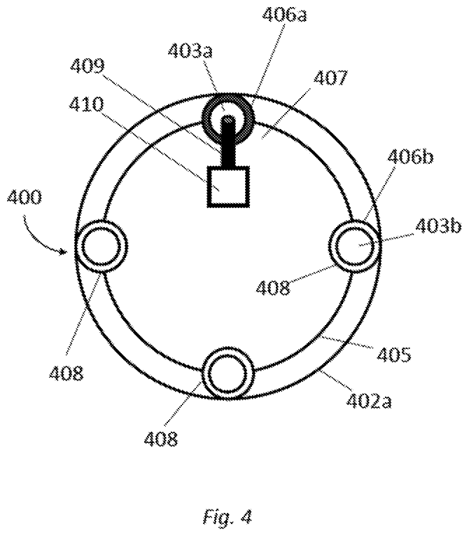

FIG. 4 schematically illustrates an example of a drive assembly 400 for a Magnus rotor. The drive assembly 400 consists of a drive wheel mechanism 407 and a plurality of idler wheel mechanisms 408. The drive wheel mechanism 407 includes a drive wheel 403a positionable to roll against a running surface 402a of a rotor, and a drive mechanism 410 connected to the drive wheel 403a. The drive mechanism 410 can be configured to provide a torque to drive rotation of the drive wheel 403a. The drive wheel 403a in turn transfers this drive torque to the running surface 402a of the rotor.

The drive wheel mechanism 407 further includes a biasing mechanism 409 configured to, in use, bias the drive wheel 403a towards the running surface 402a. More particularly, in the drive assembly 400 embodiment shown, the biasing mechanism 409 is configured to increase the degree of bias applied as the torque supplied by the drive mechanism 410 increases.

The idler wheel mechanisms 408 each comprise an idler wheel 403b. The idler wheels 403b are also configured to roll against the running surface 402a. The idler wheels 403b are freely rotatable however, meaning that they rotate about their respective wheel axes with minimal resistance or opposing torque. Therefore, in use, as the drive wheel 403a rotates the running surface 402a, the running surface 402a in turn rotates the idler wheels 403b.

In the embodiment shown, the drive wheel 403a comprises a pneumatic tyre 406a, and the idler wheels 403b each comprise a solid tyre 406b. The drive wheel 403a requires a higher coefficient of friction or preload, to facilitate the transmission of torque to the running surface 402, but may be designed to carry a lower maximum load than the idler wheels 403b, which, in use, need to withstand the thrust of the rotor. The pneumatic tyre 406a on the drive wheel 403a provides greater friction against the running surface 402a than the solid tyres 406b on the idler wheels 403b, while the solid tyres 406b on the idler wheels are longer-lasting and more hard-wearing. In other words, both types of wheel 403a, 403b uses a tyre which is optimal for their loading characteristics.

In the embodiment shown, the pneumatic tyre 406a has a cylindrical profile (e.g. as shown in the wheel 203 of FIG. 2), which is shaped to maximise the effective contact area with the running surface 402a. The pneumatic tyre 406a preferably is formed from rubber or from a material including rubber, although this need not necessarily be the case. As used herein, rubber refers to synthetic rubber compounds similar to those used in automotive tyres. Indeed, automotive tyres themselves may be suitable for the drive wheel 403a.

The solid tyres 406b may be formed from polyurethane and/or metal, or from a material including polyurethane and/or metal. Tyres comprising polyurethane or metal tend to wear less quickly, but may provide lower traction against the running surface 402a. In order to minimise wear, the solid tires 406b preferably use a polyurethane material with a Shore hardness of 70 A or harder, or a metal material with a Brinell hardness of 100 HB or harder.

In the example shown, the drive wheel 403a and the three idler wheels 403b are positioned to roll against the same running surface 402a. However, in other examples, one or more drive wheels may roll against one running surface while one or more idler wheels may roll against a different running surface.

It will be understood that the wheel assembly 300 described in relation to FIG. 3 may be modified to include one or more drive wheels and a remaining number of idler wheels, as described hereinabove, so as to define a further drive assembly according to another embodiment of the invention. More particularly, such a further drive assembly would include a plurality of wheels non-uniformly spaced apart, wherein one or more of the wheels is a drive wheel and the remaining wheels are idler wheels.

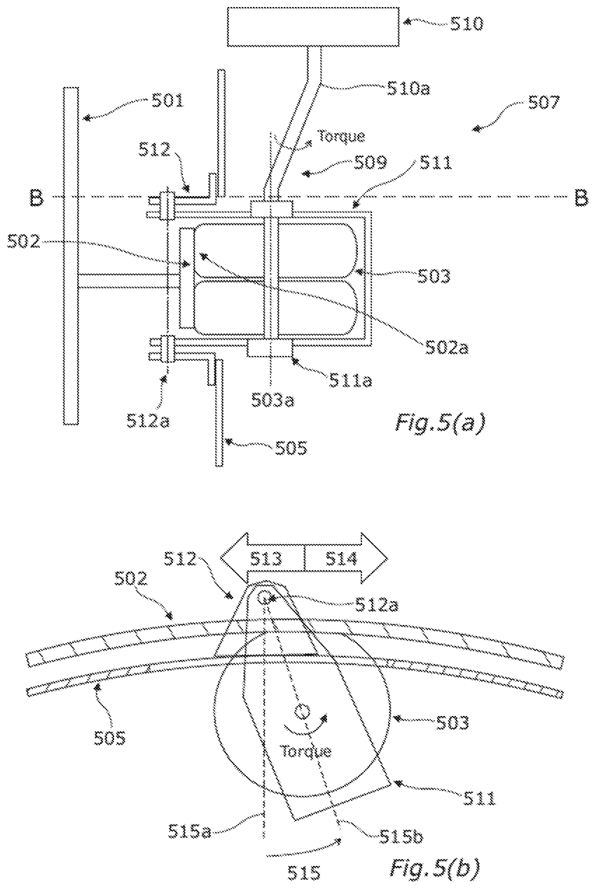

FIG. 5 shows an exemplary drive wheel mechanism 507 for use in the drive assembly 400 of FIG. 4 (or any other drive assembly, such as the further drive assembly mentioned above). The drive wheel mechanism 507 consists of a drive wheel 503, a drive mechanism 510 and a biasing mechanism 509.

The drive wheel 503 is configured to roll against the running surface of a rotor. In the embodiment shown, the running surface 502a is the inner surface of a bearing ring 502, which is attached to and rotates with a rotor 501. The drive wheel 503 is mounted to an axle such that it rotates around a wheel axis 503a. The drive wheel 503 also comprises a resiliently compressible tyre, such as a pneumatic tyre.

The drive mechanism 510 may include a motor (such as an electrical motor), turbine, or other power system. In some examples, the drive mechanism is the power source of the ship, and drive torque is transmitted to the drive wheel by means of a dedicated driveshaft.

In the embodiment shown, the drive mechanism 510 provides a torque to the wheel 503 via the biasing mechanism 509, and more specifically provides torque via a driveshaft 510a connected to the axle.

Meanwhile, the biasing mechanism 509 includes a swing mount that takes the form of a swing bracket 511 which is connected to distal ends of the axle via respective bearings 511a. The swing bracket 511 is, in turn, pivotably connected to a pair of pivot brackets 512 located on either side of the swing bracket 511 along the drive wheel axis 503a. The pivot brackets 512 are themselves fixedly mounted to a support structure 505, which may be or include a carrier and/or tower, as described herein.

The biasing mechanism 509, i.e. the swing bracket 511 and associated components, is arranged to pivot relative to the pivot brackets 512 around a pivot axis 512a. Since the drive wheel 503 is spaced from the pivot axis 512a, pivoting of the swing bracket 511 causes the wheel 503 to transcribe an arc 515 about the pivot axis 512a. The wheel 503, swing bracket 511, and pivot axis 512a are arranged relative to one another such that movement of the wheel 503 through the arc 515 alters the spacing between the wheel axis 503a and the running surface 502a. More particularly, the wheel axis 503a is furthest away from the running surface 502a when the swing bracket 511 is in a first position 515a relative to the pivot bracket 512, i.e. when the swing bracket 511 is aligned with the pivot bracket 512, and the wheel axis 503a moves towards the running surface 502a, i.e. the separation between the wheel axis 503a and running surface 502a decreases, as the swing bracket 511 pivots towards a second position 515b relative to the pivot bracket 512.

As the torque supplied by the drive wheel 503 increases, the risk of the drive wheel 503 slipping against the running surface 502a, rather than smoothly rolling, increases. Slipping results in increased wear on both the wheel 503 and running surface 502a, and is inefficient for torque transfer from the drive wheel 503 to the running surface 502a.

The biasing mechanism 509 counteracts this problem. In use, torque supplied by the drive mechanism 510 causes the drive wheel 503 to spin and apply a drive force 513 against the running surface 502a so that the rotor rotates. However, an opposing force 514 is also applied by the running surface 502a against the wheel 503, urging the wheel to roll around the running surface 502a. The opposing force 514 ultimately acts on the swing bracket 511 so that it pivots relative to the pivot bracket 512, thereby causing the wheel 503 to move through the arc 515, and thus move the wheel axis 503a closer to the running surface 502a, i.e. towards to the second position 515b, and thereby press the wheel 503 into the running surface 502, which causes compression of the wheel tyre.

As torque is increased, the drive force 513 increases so the opposing force 514 acting on the swing bracket 511 also increases and the wheel 503 is pressed into the running surface 502a to an even greater extent. In other words, there is an increased normal contact force between wheel 503 and the running surface 502a which increases the traction of the wheel 503 on the running surface 502a, allowing the drive wheel 503 to transmit higher lateral forces into the running surface 502a without slipping.

However, higher normal contact forces can themselves lead to increased wear on the wheel 503 and/or running surface 502a, as well as increased rolling resistance of the drive wheel 503 on the running surface 502a which results in more energy being needed to rotate the rotor.

Accordingly it is desirable to be able to regulate, and in particular reduce the normal contact force as required. The biasing mechanism 509 is further configured to achieve this too. More particularly, as the torque is decreased, e.g. from a maximum desired level, the drive force 513 decreases so the opposing force 514 acting on the swing bracket 511 also decreases. The resilience, i.e. compressibility, of the wheel's tyre is then able to overcome the force pressing the wheel 503 into the running surface 502a and expansion of the tyre causes the swing bracket 511 to pivot in the opposite direction (back towards the first position 515a) and as a result, traction between the wheel 503 and the running surface 502a decreases.

Thus the biasing mechanism 509 ensures that torque can be efficiently transferred from the drive wheel 503 to the running surface 502a efficiently at all speeds and levels of drive torque, without slipping or excess wear. In other words, the radial load on the drive wheel 503 varies with the drive torque so that the drive wheel 503 provides minimal rolling resistance when drive torque is low, but the radial load is high enough to generate sufficient friction to prevent wheel slip when the drive torque is high.

In other examples, the biasing mechanism may comprise a servo or pneumatic actuator configured to move the wheel axis 503a relative to the running surface 502a.

In one such example, a controller receives information about the level of drive torque (e.g. from the drive mechanism 510 itself), and then provides instructions to the servo to decrease the separation between the wheel axis 503a and running surface 502a.

In the embodiment shown, the drive wheel 503 comprises a pair of pneumatic tyres mounted in parallel along the wheel axis 503a. In other examples, the drive wheel may have a single, contiguous tire with a cylindrical profile (e.g. as shown in the wheel 203 of FIG. 2), which is shaped to maximise the effective contact area with the running surface. In some further examples, the drive wheel may be formed from rubber or from a material including rubber. Indeed, automotive tyres themselves may be suitable for the drive wheel in some examples.

The swing bracket 511 and pivot bracket 512 may be constrained such that the swing bracket 511 cannot rotate more than 15 degrees out of alignment with the pivot bracket 512. This can additionally help avoid wheel slip between the drive wheel 503 and the running surface 502a.

### Biasing Assembly

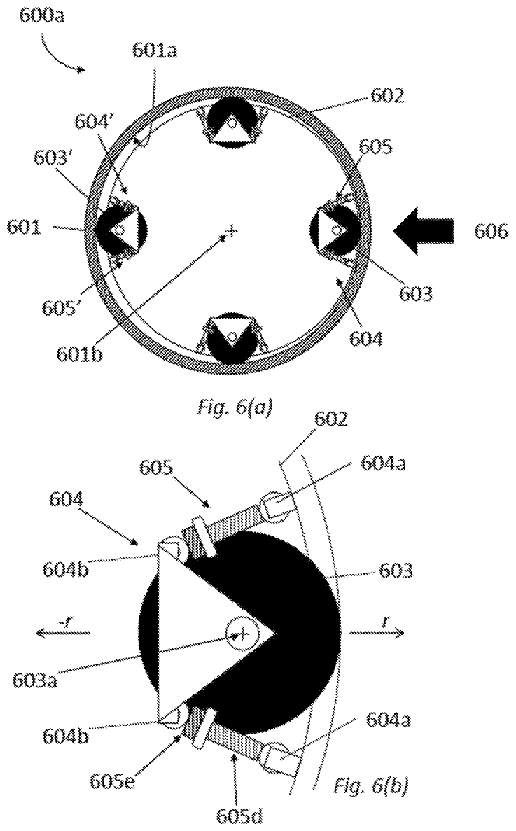

As previously discussed in relation to FIGS. 3(a) and 3(b), first and second wheel assemblies 300a, 300b may comprise a loading arrangement 307 configured to impel the wheel radially outwards. Alternatively or additionally, a biasing assembly, such as a first biasing assembly 604 as shown in FIG. 6(b), may act as a suspension system for a wheel within such a wheel assembly 300a, 300b, e.g. to absorb and dampen cyclic or transient forces between a rotor and a support structure.

Referring to FIG. 6(a), a Magnus rotor comprises a rotor 601 and support structure 602. The support structure 602 is, in use, fixedly connected to a vessel such as a ship. The rotor 601 is arranged coaxially with the support structure 602, and a third wheel assembly 600a, comprising a plurality of wheels 603, transfers loads between a running surface 601a of the rotor 601 and the support structure 602. The wheel assembly 600a and running surface 601a may be considered together as forming at least part of a lower bearing assembly.

In this example, the running surface 601a is an inner surface of the rotor 601. In other examples, the running surface may be an inner surface of a bearing ring as described herein above, or even an outer surface of a bearing ring as mentioned above.

In use, when an external load 606 is applied to one side of the rotor 601 (e.g. a gust of wind), the asymmetric loading of the rotor 601 causes increased loading on the wheel 603 proximal to the point of application of the external load 606 and decreased loading on the wheel 603′ distal to the point of application of the external load 606.

From here on, it will be understood that a prime symbol used with a reference numeral (e.g. 603′) denotes specific reference to a feature when it is in use and distal to the point of application of the external load 606.

Wheels configured solely to prevent deflection of the rotor when external loads are applied, may result cyclic or transient forces between the rotor and the support structure that would likely lead to failure of the associated Magnus rotor. Therefore, it is desirable to include in the Magnus rotor a biasing assembly, such as a first biasing assembly 604 according to an embodiment of the invention to absorb and dampen such cyclic or transient forces. Accordingly, each wheel 603 in the Magnus rotor shown in FIG. 6(a) is connected to the support structure 602 via such a first biasing assembly 604.

The first biasing assembly 604 allows the wheel 603 proximal to the external load 606 and the rotor 601 to deflect away from the direction of loading 606. However, when a wheel 603 is loaded (and deflected) on one side of the support structure 602, the wheel 603′ on the other side of the support structure 602, i.e. distal from the loading 606, becomes unloaded (and deflected) by the same distance.

It is advantageous for all wheels 603 to remain in contact with the running surface 601a with enough force such that there is no slipping between any of the wheels 603 and rotor 601, in all operating conditions, to prevent rapid wear. Accordingly, it is desirable for each biasing assembly 604 to apply a preload to its wheel 603, such that a distally loaded wheel 603′ will maintain contact with the running surface 601a even as the rotor 601 is deflected away from the support structure 602. In other words, it is desirable that each biasing assembly 604 is configured such that it applies a bias force to urge the wheels 603 towards the running surface 601a, even in the absence of any other external forces on the rotor 601.

However, if each biasing assembly 604 were to generate a constant force characteristic (e.g. wherein the biasing members are stiff elastic springs which follow Hooke's Law), with four wheels 603 the preload on each wheel 603 would have to be at least half as much as the maximum operating load of the rotor (i.e. the maximum expected value of the asymmetric force 606), meaning a total preload of double the maximum operating load. Such an arrangement would, however, have low efficiency, because rolling resistance is approximately proportional to the radial force on the wheels 603.

To solve this problem, the biasing assembly 604 includes a pair of biasing members 605 that instead each exhibit a non-constant force characteristic, thereby allowing the two functions of carrying load on the loaded side of a rotor 601 and maintaining contact on the unloaded side to be decoupled. Other embodiments (not shown) may include fewer than or more than two biasing members 605.

Each biasing member 605 includes a first coupling 604a connectable to the support structure 602. The first coupling 604a is connectable in the sense that the biasing member 605 may be selectively detached from the support structure 602, e.g. for maintenance or replacement. Each biasing member 605 also includes a second coupling 604b that is connectable to a wheel 603, such that each wheel 603 can rotate about a wheel axis 603a relative to the respective biasing member 605. In the example shown, the first coupling 604a takes the form of a mounting bracket which couples a given biasing member 605 to the support structure 602, and the second coupling 604b takes the form of a wheel bearing which supports the axle about which the wheel 603 rotates. In other examples, the first and second couplings may take a different form, so long as they interconnect a biasing member between the support structure and wheel axle.

Respective pairs of biasing members 605 are configured to urge a corresponding wheel 603 radially outwards r towards the running surface 601a, in the sense that the biasing members 605 provide a bias force which pulls the wheel 603 radially outwards towards the running surface 601a.

More particularly, the biasing members 605 urge the wheel 603 towards the running surface 601a according to a first force characteristic while the wheel axis 603a lies in a first displacement region and urges the wheel 603 towards the running surface 601a according to a second, different force characteristic while the wheel axis 603a lies in a second displacement region.

For example, if the biasing member 605 includes a spring, then a force characteristic may be the stiffness of the spring.

In the embodiment shown, each biasing member 605 includes a first biasing element 605d and a second biasing element 605e. The first and second biasing elements 605d, 605e have different force characteristics, and more particularly the first biasing element 605d has a first force characteristic and the second biasing element 605e has a second force characteristic, with the first force characteristic resulting in a lower degree of biasing being applied than as a result of the second force characteristic. Accordingly, the first biasing element 605d provides a lower degree of biasing than the second biasing element 605e.

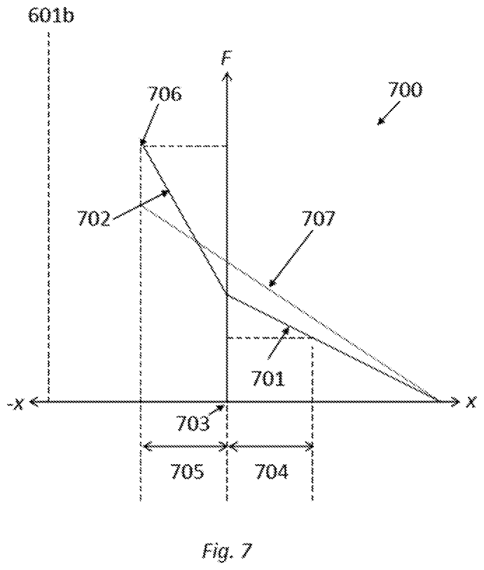

FIG. 7 shows a graph 700 of bias force F against displacement x corresponding to the force characteristics provided by each of the biasing members 605 described hereinabove. The displacement x is the displacement of the wheel axis 603a from a transition point 703 with respect to the direction r shown in FIG. 6(b). Hence, a positive displacement x represents a displacement of the wheel axis 603a in the direction of the running surface (away from the rotor axis 601b in this example) while a negative displacement −x represents a displacement of the wheel axis 603a in the opposite direction of the running surface (towards the rotor axis 601b in this example).

The transition point 703 represents the point at which a first displacement region 704 transitions to a second displacement region 705. As mentioned above, while the wheel axis lies 603a in the first displacement region 704 each non-linear biasing member 605 urges the wheel 603 towards the running surface 601a according to a first force characteristic 701, as provided by the first biasing element 605d and represented by the gradient of the first force characteristic 701. Meanwhile, when the wheel axis 603a lies in the second displacement region 705 each non-linear biasing member 605 urges the wheel 603 towards the running surface 601a according to a second force characteristic 702, as provided by the second biasing element 605e and represented by the gradient of the second force characteristic 702.

When installed for use, each biasing assembly 604 may be configured so that the wheel axis 603a lies at the transition point 703 when the rotor 601 experiences no external loads 606 which would otherwise cause a deflection of the running surface 601a. In some examples, each biasing member is adjustable to allow alteration of the transition point and application of a preload to one or both of the biasing elements. In still further examples, the biasing elements themselves comprise adjustment mechanisms which allow their preloading levels to be adjusted independently.

Accordingly, during use when there are no external loads effective on a particular biasing assembly 604, the bias force F provided by the respective biasing members 605 therein is that associated with the transition point 703. As shown in the graph 700 of FIG. 7, the bias force F at the transition point 703 is generated entirely, or almost entirely, according to the first force characteristic 701, i.e. by the first biasing element 605d of each biasing member 605 due to a preload applied to the said first biasing element 605d. Little or no bias force F may be provided by the second biasing element 605e. Furthermore, at the transition point 703, the given biasing members 605 preferably are configured so that the first biasing element 605d is providing its maximum bias force F such that no additional bias force F may be provided by the first biasing element 605d. This may be achieved with the presence of a mechanical stop, for example.

When an external load 606 is applied to the rotor 601 it travels through the running surface 601a to the wheel 603 proximal to the application of load 606, and then to the corresponding biasing assembly 604. In response to the increased load, the biasing members 605 of the biasing assembly 604 oppose the load with an increased bias force F because, as the wheel 603 deflects inwardly (towards the rotor axis 601b), the wheel axis 603a moves into the second displacement region 705 and the biasing member 605 then urges the wheel 603 towards the running surface according to the second force characteristic 702 of the second biasing element 605e.

The inward deflection of the wheel 603 proximal to the application of load 606 allows the running surface 601a distal to the application of load 606 to deflect outwardly (as shown in the left-hand side of FIG. 6(a)). This reduces the load exerted on the wheel 603′ distal to the application of load 606 and hence reduces the load on the corresponding biasing assembly 604′. As the load to be opposed reduces, the bias force F generated by the biasing members 605′ of the biasing assembly 604′ also reduces by virtue of preload in the first biasing element 605d′ being expelled. In other words, as the wheel axis 603a′ of the wheel 603′ distal to the load moves into the first displacement region 704 the respective biasing members 605′ urge the wheel 603′ towards the running surface 601a according to the reducing first force characteristic 701 provided by the corresponding first biasing elements 605d′.

The first biasing element 605d may be or include a coil spring, a leaf spring, a pneumatic actuator and/or a hydraulic actuator (or other type of fluid actuator). Such components can be designed with an end stop and such that they have a low effective stiffness until the end stop displacement is reached (at the transition point 703). The force characteristic selected for the first biasing element may be a compromise between different requirements. As discussed, the force keeping the wheel 603 in contact with the running surface 601a should be as low as possible while maintaining sufficient grip to keep the wheel 603 turning. The effective stiffness should therefore be much lower than the effective stiffness of the second biasing element 605e so that when the second biasing element 605e deflects, the opposite wheel 603′ (i.e. the wheel on the other side of the support structure) does not lose too much contact force due to the extension of its first biasing element 605d from the initial preloaded position. In other words, the first biasing element should be selected or configured so that first force characteristic 701 has a shallow gradient on the graph 700.

However, if the first biasing element's 605d effective stiffness is too low (or effectively zero stiffness if the preloading comes from gravity or for example from a pneumatic or hydraulic actuator with a pressure reservoir) then its dynamic behaviour may become unpredictable.

The second biasing element 605e may be or include a resilient block, optionally formed from or including an elastomeric material. A resilient block, such as a solid rubber block, can be made to have a higher effective stiffness than any actuator or spring. The force characteristic selected for the second biasing element 605e may also be a compromise. The second biasing element 605e should preferably be stiff enough such that it can adequately resist the largest loads without letting the rotor 601 hit the support structure 602, but not be so effectively stiff that it causes unnecessarily high cyclic loads on the wheels 603 or biasing assemblies 604 due to runout (non-circularity) of the wheels 603 or running surface 601a. For example, if the effective stiffness of the second biasing element 605e was 10 kN/mm, a runout (non-circularity) on the running surface 601a of 2 mm would cause a 20 kN cyclic load, repeating once every rotation. As the rotor will be running continuously for much of the operating life, this can add up to a substantial amount of stress cycles.

The effective stiffness of the second biasing element 605e may be selected such that it is stiff enough to prevent resonant oscillation of the rotor 601a in a desired operating speed range. Biasing assemblies 604 with low effective stiffnesses can result in resonances in the operating speed range of the rotor caused by a small imbalance of the rotor. This is undesirable as it can make it necessary to avoid parts of the operating speed range of the rotor, thereby truncating the operating speed range of the rotor. It will also increase wear/fatigue when the rotor is passing through that part of the speed range. For example on a 5 m×35 m rotor 601, the rotor mass may be in the region of 20 tonnes, the moving mass effective on the lower bearing assembly is then approximately 10 tonnes, and has a maximum operating speed of 180 rpm. As such, an estimate of the minimum stiffness required to keep the resonant mode out of the operating range can be calculated via the following equations:

$$Max operating speed = 180 rpm \approx 20 {rads}^{- 1} \qquad ( 1 )$$

$$Natural frequency = ω = \sqrt{\frac{{k}_{min}}{m}} \qquad ( 2 )$$

$${k}_{min} = m {ω}^{2} = 10 \times 2 {0}^{2} = 4 {kNmm}^{- 1} \qquad ( 3 )$$

As such, the second force characteristic 702 of the biasing members 605 in each biasing assembly 604 for a typical 5 m×35 m rotor 601 should represent a stiffness effective on the rotor substantially more than 4 kN/mm. In order to avoid resonance, in some examples the second force characteristic should represent a stiffness effective on the rotor that is at least double the moving mass of the rotor multiplied by the square of a desired maximum operating angular velocity of the rotor. In some examples, the effective stiffness is between 1× and 4× the minimum stiffness required to prevent a resonant rigid-body vibration of the rotor in the operating speed range.

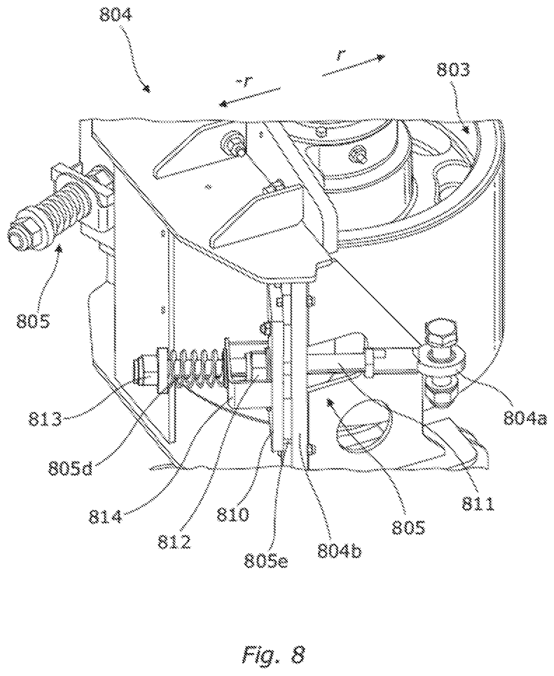

FIG. 8 shows an example of a second biasing assembly 804 according to a further embodiment of the invention, specifically showing a corresponding biasing member 805 within the second biasing assembly 804 in more detail. The biasing member 805 is coupled to a support structure (not shown) via a first coupling 804a and to a wheel 803 via a second coupling 804b, and as such the second biasing assembly 804 is entirely interchangeable with the first biasing assembly 604 described hereinabove.

The biasing member 805 shown comprises a first biasing element 805d and a second biasing element 805e. More particularly, the first biasing element 805d includes a coil spring and the second biasing element 805e includes a pair of resilient blocks, each formed from a solid elastomeric material.

The second coupling 804b is connected to the second biasing element 805e which is, in series, connected to a plate 810. Meanwhile, the first coupling 804a is connected to a rod 811 extending from the first coupling 804a through the second coupling 804b, between the two resilient blocks of the second biasing element 805e and through the plate 810. Affixed to the rod 811 is a transition nut 812. The transition nut 812 is threadedly engaged with and movable along the rod 811 but only through application of a sufficient torsional force. Thus, the transition nut 812 may be rotated along the rod 811 to a given position by an operator, such as an installer of the second biasing assembly 804, and then remain fixed in that position until another torsional force is applied.

Accordingly, the rod 811 is anchored to the support structure via the first coupling 804a and the transition nut 812 may be fixed at a selected distance from the first coupling 804a (and hence from the support structure). On the other hand, the second coupling 804b, second biasing element 805e and plate 810 are freely movable along the rod 811, this movement facilitating movement of the wheel 803 relative to the support structure. However, the plate 810 is configured to abut against the transition nut 812 meaning that any additional movement of the wheel 803 towards the rotor axis (i.e. in a −r direction) requires compression of the resilient blocks of the second biasing element 805e.

As can be seen in FIG. 8, the rod 811 extends beyond the transition nut 812 and through the coil spring of the first biasing element 805d to a preload nut 813. The preload nut 813 is similar to the transition nut 812 in that it may be rotated along the rod 811 to a given position and then remain fixed in that position such that, in use, it is a fixed distance from the first coupling 804a and support structure. In order for the first biasing element 805d to apply a force urging the wheel 803, a shelf 814 is mounted a fixed distance from the plate 810. The shelf 814 provides a surface for the coil spring to exert a force upon while bypassing obstruction that would otherwise be caused by the transition nut 812. When a rotor deflects away from the rotor axis, the load acting on the first biasing element 605d will reduce, and the coil spring will extend so that the shelf 814 and hence the plate 810 move radially outward (in direction r) away from the transition nut 812. This, in turn, causes the wheel 803 to be moved radially outward (in direction r), thereby keeping the wheel in the rolling contact with an associated running surface of the rotor.

It may be noted that the second biasing element 805e may be selected to be stiff enough that it exhibits no compression (or negligible compression) in response to loading applied upon it by the first biasing element 805d, thus ensuring that only first biasing element 805d is acting when the wheel axis (not shown in FIG. 8) is in the first displacement region 704 (i.e. as shown in FIG. 7).

At the point of installation, the biasing member 805 may be configured to a desired setting by suitably positioning the transition nut 812 and the preload nut 813. Firstly, the transition nut 812 is positioned so that when the rotor is rotating under normal conditions (i.e. with no external load acting to deflect the rotor) the position of the wheel 803 as it rolls against the running surface of the rotor will cause the plate 810 to abut against the preload nut 813 but there will be no compression of the second biasing element 805e. Thus, the resilient block will only begin urging the wheel 803 away from the rotor axis (in direction r) in response to an external load deflecting the rotor in the opposite direction. In other words, this positioning of the transition nut 812 sets the transition point 703 (shown in FIG. 7) at which point the second biasing element 805e begins acting on the wheel in addition to the first biasing element 805d.

Secondly, the preload nut 813 is positioned so that the first biasing element 805d is sufficiently compressed to provide a sufficient preload. A sufficient preload ensures sufficient force is applied by the first biasing element 805d to urge the wheel 803 away from the rotor axis (in direction r) so that it remains in rolling contact with the running surface even when the rotor is deflected away from that wheel 803. Accordingly, a sufficient preload may be set so that the first biasing element 805d is still sufficiently loaded to keep the wheel 803 in rolling contact with the running surface when the rotor deflects a maximum expected amount in direction r. However, as mentioned above, it is desirable that the load applied by the first biasing element 805d is not substantially higher when the rotor is rotating under normal conditions (i.e., with no external loading) and this can be achieved through selection of the first biasing element (e.g. the stiffness of the coil spring).

### Gimballed Wheel Mechanism

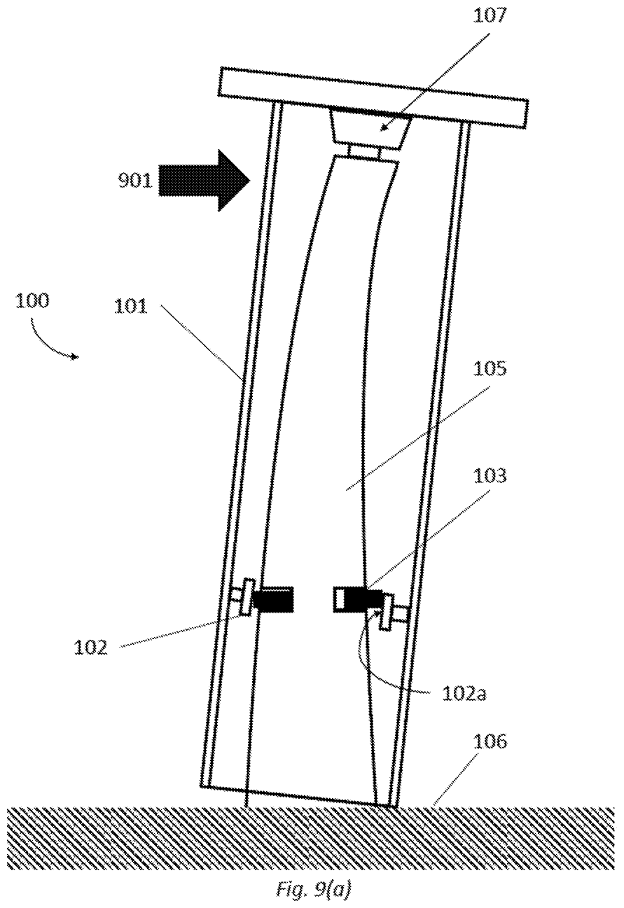

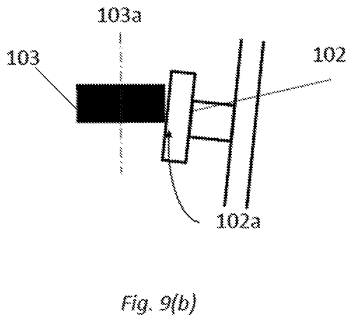

Another contributor to excess wear in Magnus rotors is caused by the deformation of components under load. FIG. 9(a) shows a simplified version of the Magnus rotor 100 of FIGS. 1(a) and 1(b), with the rotor 101 joined through an upper bearing assembly 107 to a carrier 105 and configured to rotate around the carrier 105. A wheel assembly comprises the plurality of wheels 103 which each make contact with the running surface 102a on the bearing ring 102 running around the inner surface of the rotor 101. Each wheel 103 is mounted relative to the carrier 105 such that the wheel can rotate about a wheel axis 103a, as shown in FIG. 9(b) which illustrates and enlarged view of one such wheel 103. The wheels 103 are substantially cylindrical, which as previously discussed maximises their contact area with the running surface 102a.

In use, when a load 901 is applied by the rotor 101 into the carrier 105, it can cause the carrier 105 to bend in the direction of the applied load 901. This in turn leads to the rotor 101 becoming tilted relative to a deck 106 to which the carrier 105 is, in use, secured, as the upper bearing assembly 107 connected to the top of the carrier 105 is displaced. As a result, the wheel axes 103a of one or more wheels 103 may become misaligned with the running surface 102a, e.g. as best shown in FIG. 9(a). As a consequence, rather than making contact with the running surface 102a along its full height, the or each misaligned wheel only makes contact with the running surface 102a along an edge or smaller contact region. This results in increased local contact stresses and asymmetric loading in such a misaligned wheel 103 and the running surface 102a, accelerating their respective rates of wear.

The degree of bending and displacement in Figures (a) and 9(b) has been exaggerated for the purposes of clarity. However, it will be understood that even small degrees of bending and displacement can result in misalignment between a wheel axis 103a and the running surface 102a of the bearing ring 102. In addition, manufacturing defects and tolerances in components such as the running surface 102a, carrier 105, and/or wheels 103 can also lead to misalignment of one or more wheel axes 103a with the running surface 102a.

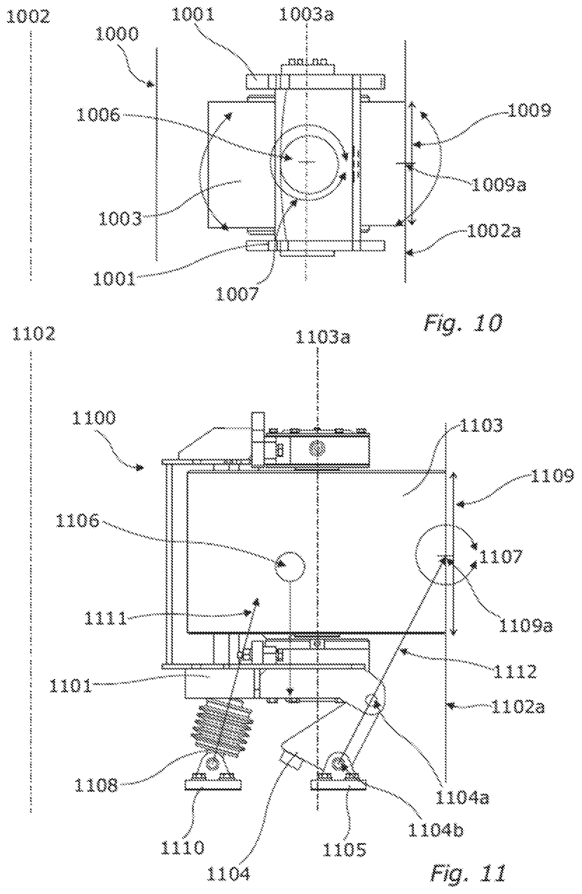

Accordingly, FIGS. 10 and 11 show first and second gimballed wheel mechanisms 1000, 1100 for a Magnus rotor, which are configured to eliminate such wheel misalignment. The first and second gimballed wheel mechanisms 1000, 1100 each comprises a mounting assembly 1001, 1101 which rotatably supports a wheel 1003 in use relative to a support structure (not shown), 1103 via bearings, such that each wheel 1003, 1103 can rotate about a corresponding wheel axis 1003a, 1103a relative to the said mounting assembly 1001, 1101. Each wheel 1003, 1103 is configured to run against a corresponding running surface 1002a, 1102a of a rotor. Neither rotor is itself shown, except for its respective axis of rotation 1002, 1102. As previously described, the running surface 1002a, 1102a may be an inner or outer surface of a bearing ring connected to the inner wall of the rotor, or it may be the wall of the rotor itself.

In any event, in each case the wheel axis 1003a, 1103a and rotor axis 1002, 1102 lie in a common radial plane. For example, in each of FIGS. 10 and 11, both the wheel axis 1003a, 1103a and rotor axis 1002, 1102 lie within the plane of the figure itself, and thus such a plane defines the common radial plane. The radial plane may additionally be aligned with a radius or diameter of the rotor or carrier (since the rotor may be arranged to rotate coaxially about the carrier).

Each mounting assembly 1001, 1101 includes a gimballing support, which allows the wheel axis 1003a, 1103a to pivot about a corresponding gimballing axis 1007, 1107 such that each wheel axis 1003a, 1103a remains aligned with the corresponding running surface 1002a, 1102a of the rotor. Each gimballing axis 1007, 1107 is perpendicular to the corresponding wheel axis 1003a, 1107a and perpendicular to the corresponding radial plane common to the corresponding rotor axis 1002, 1102 and corresponding wheel axis 1003a, 1103a. In other words, each gimballing axis 1007, 1107 extends normally to the plane of the figures of FIGS. 10 and 11 themselves.

Each wheel 1003, 1103 is, as mentioned, substantially cylindrical, with a diameter D and an axial height H (, e.g. as shown in relation to the similar wheel 203 of FIG. 2, with the height H being measured along the direction of the wheel axis 1003a, 1103a). The axial height H preferably is at least 50% of the wheel diameter, so as to decrease the contact stresses within the wheel 1003, 1103, although this need not necessarily be the case.

In any event, when each wheel 1003, 1103 and corresponding running surface 1002a, 1102a are correctly aligned, i.e. as shown in each of FIGS. 10 and 11, the contact surface between the wheel 1003, 1103 and running surface 1002a, 1202a can be approximated as a line extending along the running surface 1002a, 1102a parallel with and coplanar to the wheel axis 1003a, 1103a. Each such contact surface may be referred to as a line of contact 1009, 1109. Moreover, in the embodiments shown, each line of contact 1009, 1109 has a length substantially equal to the height H of the wheel 1003, 1103 (i.e. as previously defined in relation to FIG. 2). Each cylindrical wheel 1003, 1103 is symmetrical about a plane normal to the wheel axis 1003a, 1103a and passing through a midpoint 1009a, 1109a of the corresponding line of contact 1009, 1109.

Since the loading forces between each wheel 1003, 1103 and corresponding running surface 1002a, 1102a are primarily (a) loading forces normal to the line of contact 1009, 1109 or (b) axial friction forces coplanar with the line of contact 1009, 1109, such loading forces can all be considered to act through the corresponding midpoint, such that each midpoint may be referred to as a respective centre of effort 1009a, 1109a.

In the first gimballed wheel mechanism 1000 of FIG. 10, the gimballing axis 1007 is arranged to pass through a centre of gravity 1006 of the wheel 1003, which helps to minimise the complexity of the corresponding first mounting assembly 1001 which can take the form of a relatively simple mounting bracket that defines the gimballing support.

However, when the gimballing axis 1007 passes through the centre of gravity 1006, any misalignment between the wheel axis 1003a and the rotor axis 1002 can cause ‘tipping’ of the wheel 1003 (i.e., an overturning moment is placed upon the wheel) about the gimballing axis 1007. This is because if the wheel's 1003 rolling direction is not exactly aligned with the direction of motion of the running surface 1002a, there is a resultant slipping velocity in a direction axial to the wheel 1003, causing a friction force. This slipping velocity is a function of the misalignment; for example if the wheel axis 1003a and rotor axis 1002 were 1° misaligned, and travelling at 25 m/s linear speed, the slipping velocity would be 25*sin (1)=0.4 m/s. This can cause the wheel 1003 to tip about the gimballing axis 1007, leading to an uneven contact pressure along the line contact 1009 of the wheel, and faster wear at one edge of the wheel.

To help mitigate this problem, the second gimballed wheel mechanism 1100 of FIG. 11 includes a gimballing axis 1107 that is instead configured to extend approximately through the centre of effort 1109a, i.e. either directly through or substantially close to the centre of effort 1109a, rather than the centre of gravity 1106 of the wheel 1103.

Additionally, to allow the wheel axis 1103a to pivot about the gimballing axis 1107, the second gimballed wheel mechanism 1100 includes a second mounting assembly 1101 which, in use, is pivotally coupled to a carrier, tower or other support structure by a gimballing support in the form of an angled linkage 1104 and associated first mounting leg 1105, although other types of gimballing support are also possible. More particularly, a first pivot point 1104a at one end of the angled linkage connects the angled linkage 1104 to the mounting assembly 1101, and a second pivot point 1104b at a second end connects the angled linkage 1104 to the mounting leg 1105 which, in turn, can be fixed to the carrier, tower or other support structure. Hence, the wheel axis 1103a may be considered as pivotable about the gimballing axis 1107 relative to the carrier, tower or other support structure. A gimballing support axis 1112 extends through the first 1104a and second 1104b pivots, which are assumed to be frictionless such that the angled linkage 1104 can only transmit a force between the mounting leg 1105 and mounting assembly 1101 along the gimballing support axis 1112. This force may be referred to as the gimballing support force. The pivots 1104a, 1104b and angled linkage 1104 are arranged such that the gimballing support axis 1112 is substantially coincident with the centre of effort 1109a. That is, the gimballing support axis 1112 passes through or close to the centre of effort 1109a, such that the gimballing support force is directed substantially into the centre of effort 1109a. This helps to ensure that the gimballing support force does not generate a turning moment around the centre of effort 1109a, which could otherwise cause one edge of the wheel 1103 to press into the running surface 1102a harder than the opposite edge and thereby increase wear.

In the embodiment shown, the second mounting assembly 1101 is additionally coupled, in use, to a carrier, tower or other support structure by a biasing support in the form of a biasing member 1108 and associated second mounting leg 1105, although again other forms of biasing support are also possible.

Similarly to the angled linkage 1104, one end of the biasing member 1108 is pivotably connected to the second mounting assembly 1101 and another end is pivotably connected to the mounting leg 1110 which, in turn can be fixed to the carrier, tower or other support structure. The aforementioned arrangement of the gimballing axis 1107 passing through the centre of effort 1109a, and the gimballing support force similarly acting along the gimballing support axis 1112 and through the centre of effort 1109a, the weight of the wheel 1103, i.e. acting through its centre of gravity 1106, and the weight of mounting assembly 1101, i.e. the overall weight of the second gimballed wheel mechanism 1100, have a tendency to cause an overturning moment about the gimballing axis 1107. If not counteracted, this moment, i.e. rotational force, would cause the wheel axis 1103a and rotor axis 1102 to become misaligned, leading to uneven and/or excessive wear on one edge of the wheel 1103. The biasing member 1108, however, is arranged to provide a bias force 1111 (or in other examples, a bias torque) to counteract the rotational force arising from the weight of the wheel 1103 and mounting assembly 1101, i.e. from the overall weight of the second gimballed wheel mechanism 1100. The bias force 1111 also serves to push the wheel 1103 outwards against the running surface 1102a, which is advantageous to keep the wheel 1103 and running surface 1102a in contact at all times. The biasing member 1108 may comprise a spring as shown, or another actuator such as a fluid piston or resilient member. In other examples, the biasing member may comprise a counterweight positioned to counteract the weight forces from the wheel 1103 and mounting assembly 1101.

In some examples, the second mounting assembly may be coupled to a support structure of some description by a plurality of angled linkage arms 1104, with their first pivots arranged along a mutual first axis and their second pivots arranged along a mutual second axis. Spreading the loading forces through multiple linkage arms 1104 reduces the stresses and bending moments in each individual linkage arm 1104.

### ADDITIONAL EXAMPLES

It is anticipated that any two, or more, examples, or embodiments of the invention described above may be combined together for use in a single Magnus rotor.

In one example, the Magnus rotor 100 (of FIGS. 1(a) and 1(b)) may be readily adapted to include the first wheel assembly 300a (FIG. 3(a) or the second wheel assembly 300b (FIG. 3(b)). One compromise in the configuration of the Magnus rotor 100 is that a reduced size, i.e. reduced diameter, of running surface 102a results in wheels 103 that are arranged closer together than they would if the running surface was larger, thus potentially leaving less space available within the tower 105a. Such a compromise can be negated by adopting the non-uniform spacing of the wheels according to their expected loading as contemplated in each of the first and second wheel assemblies 300a, 300b, i.e. by removing potentially superfluous wheels and thereby providing more space within the tower 105a.

In another example, the Magnus rotor 100 (of FIGS. 1(a) and 1(b)) may also be readily adapted to include the drive assembly 400 of FIG. 4. That is, one or more of the wheels 103 in the Magnus rotor 100 may be configured as a drive wheel 403a, and one or more of the remaining wheels 103 may be configured as idler wheels 403b. As previously described, it may be advantageous to drive rotation of the rotor through the wheels 103 rather than through the upper bearing assembly 107. Since the drive and idler wheels both run against a common running surface 102a, it may be advantageous to use a first tyre composition for the drive wheels and a second tyre composition for the idler wheels, so as to minimise rolling friction while avoiding slipping. In a further example, the Magnus rotor 100 may be adapted to include one or more drive wheel mechanisms 507 as shown in FIG. 5. Such a drive wheel mechanism 507 would advantageously ensures that any wheel 103 which is to be a drive wheel 403a is kept in contact with the running surface 102a as the drive force 513 applied by the drive wheel 403a increases, further reducing wear caused by slipping.

In a still further example, the Magnus rotor 100 (of FIGS. 1(a) and 1(b)) may be readily adapted to include one or more biasing assemblies 604 as shown in FIGS. 6(a) and 6(b). That is, one or more wheels 103 in the Magnus rotor 100 may be connected to the carrier 105 or tower 105a via such a biasing assembly 604, whereby the or each such biasing assembly 604 reduces wear by ensuring that the corresponding wheel 103 remains in contact with the running surface 102a as the rotor 101 is deflected relative to the carrier 105, by absorbing resonant oscillations in the Magnus rotor's operating speed range.

In yet another example, the Magnus rotor 100 (of FIGS. 1(a) and 1(b)) may be readily adapted to include one or both of the first gimballed wheel assembly 1000 (of FIG. 10) and the second gimballed wheel assembly 1100 (of FIG. 11). That is, one or more wheels 103 of the Magnus rotor 100 may be connected to the carrier 105 or tower 105a via one or other of the first and second gimballed wheel assemblies 1000, 1100. Such first and second gimballed wheel assemblies 1000, 1100 would reduce wear on the or each wheel 103 so connected and the running surface 102a, by allowing the wheels 103 to remain aligned with the running surface 102a as the rotor 101 and carrier 105 deform relative to one another under the application of a load.

In some further examples, each of the first and second wheel assemblies 300a, 300b (of FIGS. 3(a) and 3(b)) may include the drive assembly 400 of FIG. 4. That is, one or more wheels 303 of either the first wheel assembly 300a or the second wheel assembly 300b may be configured as a drive wheel 403a, and one or more remaining wheels may be configured as idler wheels 403b. The position of the or each drive wheels 403b may be selected to maximise torque transfer efficiency, taking account of the uneven radial loading of the rotor in use. For example, the portside wheel 303p and the starboard side wheel 303s in the second wheel assembly 300b of FIG. 3(b) may be configured as drive wheels 403a. In some examples, the first and second wheel assemblies 300a, 300b may utilise the biasing assembly 604 of FIGS. 6(a) and 6(b) for connecting, in use, the wheels 303 which are configured as idler wheels 403b to a support structure 302. Such an adapted first or second wheel assembly 300a, 300b may be provided for retrofitting to an existing Magnus rotor 100.

In other examples, the biasing assembly 604 of FIGS. 6(a) and 6(b) may be readily adapted to include the first gimballed wheel assembly 1000 (FIG. 10) or the second gimballed wheel assembly 1100 (FIG. 11), or vice versa. In other words, a single assembly is configured to urge a wheel radially outwards, absorb uneven radial loads, and also to allow the wheel to deflect so as to stay aligned with a running surface in use. Providing this functionality in a single assembly allows for easier installation compared to providing a separate biasing assembly 604 and first or second gimballed wheel assembly 1000, 1100 for a given wheel.

In a final example, the Magnus rotor 100 (of FIGS. 1(a) and 1(b)) may be readily adapted to include the first wheel assembly 300a (FIG. 3(a)) and thereby additionally benefit from the advantages of non-uniform wheel spacing. Further, such a first wheel assembly 300(a) may be readily adapted to include the drive wheel mechanism 507 (FIG. 5(a)) and thereby additionally provide the advantages of a drive wheel 503 having a different tyre composition to the idler wheels and a torque-dependent biasing mechanism.

While such a drive wheel 503 benefits from the torque-dependent biasing mechanism, each of the idler wheels 403b of FIG. 4 may be coupled to the carrier 105 of FIG. 1(a) via a biasing assembly 604 FIGS. 6(a) and 6(b), and thus benefit from displacement-dependent biasing away from the rotor axis 101a.

Furthermore, one or more of the drive wheel 503 and idler wheels 403b may be mounted to the carrier 105 using a first gimballed wheel mechanism 1000 (FIG. 10) to maintain alignment of the wheel 503, 403b with the running surface 102a (FIG. 1).

1. A Magnus rotor comprising:
a rotor rotatable about a rotor axis and having an external surface defining a rotor diameter, the rotor having an internal running surface defining a running surface diameter no greater than 80% of the rotor diameter;
a support structure configured to rotatably support the rotor; and,
a plurality of wheels, each wheel being rotatably mounted to the support structure so as to rotate about a respective wheel axis extending substantially parallel to the rotor axis and being positioned such that the wheel rolls against the internal running surface as the rotor rotates about the support structure.

2. A Magnus rotor according to claim 1, wherein the running surface diameter is no greater than 70% of the rotor diameter; preferably, no greater than 60% of the rotor diameter.

3. A Magnus rotor according to claim 1, wherein each wheel has an outer surface defining a wheel diameter at least 10% of the rotor diameter.

4. A Magnus rotor according to claim 1, wherein:
the plurality of wheels are spaced apart from one another about a pitch circle such that each wheel axis extends through the pitch circle; and,
the pitch circle defines a pitch diameter no greater than 70% of the rotor diameter; preferably no greater than 50% of the rotor diameter.

5. A Magnus rotor according to claim 1, wherein:
the support structure comprises a hollow tower having a wall with a substantially circular cross-sectional shape; and,
at least one of the plurality of wheels lies at least partially within an outer diameter of the tower.

6. A Magnus rotor according to claim 5, wherein one or more of the wheels lying at least partially within the outer diameter of the tower is positioned so that a majority of the or each wheel lies within the outer diameter of the tower.

7. A Magnus rotor according to claim 1, wherein the rotor further includes:
a bearing ring having an inner surface or outer surface that is the running surface of the rotor; and,
a radial flange configured to have an annulus shape with an inner edge that is connected to an outer surface of the bearing ring, and an outer edge which is connected to an inner surface of the rotor.

8. A Magnus rotor according to claim 7, wherein the radial flange comprises an accessway.

9. A Magnus rotor according to claim 1, wherein at least one wheel has an axial height at least 50% of the wheel diameter.

10. A Magnus rotor according to claim 1, wherein at least one wheel comprises a substantially cylindrical outer surface.

11. A Magnus rotor according to claim 1, wherein at least one wheel comprises a solid tyre; preferably a solid tyre including polyurethane or a completely polyurethane solid tyre.

12-39. (canceled)

40. A Magnus rotor according to claim 54, wherein:
the one or more drive wheels is a plurality of drive wheels and the at least one biasing mechanism is a respective plurality of biasing assemblies; and,
a second force characteristic of each biasing assembly replicates a stiffness and the second force characteristics of the plurality of biasing assemblies replicate a stiffness effective on the rotor in use that is greater than a desired moving mass of the rotor multiplied by the square of a desired maximum operating angular velocity of the rotor.

41. A Magnus rotor according to claim 40, wherein the stiffness effective on the rotor in use is between 1.5 times and 10 times the effective moving mass of the rotor multiplied by the square of the maximum operating angular velocity of the rotor; preferably, between 2 times and 5 times the effective moving mass of the rotor multiplied by the square of the maximum operating angular velocity of the rotor.

42-53. (canceled)

54. A Magnus rotor according to claim 1, wherein the plurality of wheels define a drive assembly for the Magnus rotor, the drive assembly comprising:
one or more drive wheel mechanisms, the or each drive wheel mechanism including a drive wheel positionable to, in use, roll against the internal running surface of the rotor, and a drive mechanism for supplying torque to drive rotation of the drive wheel and, in use, the rotor; and,
one or more idler wheel mechanisms, the or each idler wheel mechanism including an idler wheel that is freely rotatable and positionable to, in use, roll against the internal running surface of the rotor as the rotor rotates,
wherein:
at least one drive wheel comprises a first tyre having a first tyre composition and at least one idler wheel comprises a second tyre having a second tyre composition different to the first tyre composition; and/or,
at least one drive wheel mechanism further includes a biasing mechanism configured to, in use, bias the corresponding drive wheel towards the internal running surface, the biasing mechanism configured to increase the degree of bias applied as the torque supplied by the drive mechanism increases.

55. A Magnus rotor according to claim 1, wherein the plurality of wheels define a wheel assembly for the Magnus rotor, the wheel assembly comprising:
the support structure, wherein the support structure defines a pitch circle;
at least one wheel mounted to the support structure and rotatable about a wheel axis to, in use, roll against the internal running surface of the rotor as the rotor rotates; and
at least one biasing assembly comprising:
a first coupling connected to the support structure;
a second coupling connected to the at least one wheel, whereby in use the wheel rolls against the internal running surface of the rotor as the rotor about the rotor axis; and
a biasing member interconnecting the first and second couplings and configured to urge the wheel axis, in use, towards the internal running surface with a displacement dependent degree of force, wherein the biasing member urges the wheel towards the internal running surface according to a first force characteristic while the wheel axis lies in a first displacement region and urges the wheel towards the internal running surface according to a second, different force characteristic while the wheel lies in a second displacement region.

56. A Magnus rotor according to claim 1, wherein at least one wheel forms a part of a gimballed wheel mechanism for the Magnus rotor, the gimballed wheel mechanism comprising:
a wheel rotatable about a wheel axis to, in use, roll against an internal running surface of the rotor as the rotor rotates about the rotor axis; and
a mounting assembly rotatably supporting the wheel, in use relative to the support structure, and including a gimballing support configured to allow pivoting of the wheel axis about a gimballing axis which extends substantially perpendicularly to the wheel axis, wherein, in use, the wheel axis and the rotor axis extend along a substantially common radial plane and the gimballing support is configured such that the gimballing axis additionally extends substantially perpendicularly to the radial plane.
